(19) United States
(12) Patent Application Publication
(10) Pub. No.: US 2022/0318602 A1
(43) Pub. Date: Oct. 6, 2022

(54) PROVISION OF SEMANTIC FEEDBACK ON DEEP NEURAL NETWORK (DNN) PREDICTION FOR DECISION MAKING

(71) Applicant: FUJITSU LIMITED, Kanagawa (JP)

(72) Inventors: Ripon K. SAHA, Santa Clara, CA (US); Mukul R. PRASAD, San Jose, CA (US); Indradeep GHOSH, Cupertino, CA (US)

(73) Assignee: FUJITSU LIMITED, Kanagawa (JP)

(21) Appl. No.: 17/301,362

(22) Filed: Mar. 31, 2021

(51) Int. Cl. G06N 3/04; G06N 3/08

(52) U.S. Cl. CPC G06N 3/0472; G06N 3/08

(57) ABSTRACT

According to an aspect of an embodiment, operations may include predicting, by a pre-trained DNN, a first class for a first datapoint of a first dataset. A first set of feature scores is determined for the first datapoint based on the first class associated with the first datapoint. A set of confusing class pairs associated with the DNN is identified based on the first class and a predetermined class of the first datapoint. The first dataset is clustered into one of a set of semantic classes based on the first set of feature score, the first class, and the set of confusing class pairs for each datapoint in the first dataset. Each semantic class indicates a prediction accuracy of a dataset clustered in the semantic class. A classifier is trained based on the clustered first dataset, the first set of feature scores, and the set of semantic classes.

### FIELD

The embodiments discussed in the present disclosure are related to provision of semantic feedback on deep neural network (DNN) prediction for decision making.

### BACKGROUND

Recent advancements in the field of neural networks have led to development of various techniques for classification of data which may be associated with various real-time applications. For example, a trained Deep Neural Network (DNN) may be utilized in different applications for various classification tasks, such as classification or detection of different datapoints (i.e. an image).

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

According to an aspect of an embodiment, operations by a device may include receiving a first dataset associated with a real-time application. The operations may further include predicting, by a Deep Neural Network (DNN) pre-trained for a classification task of the real-time application, a first class associated with a first datapoint of the received first dataset. The operations may further include determining a first set of feature scores for the first datapoint based on the predicted first class associated with the first datapoint. The operations may further include identifying a set of confusing class pairs associated with the DNN based on the predicted first class and a predetermined class associated with the first datapoint. The operations may further include clustering the received first dataset into one of a set of semantic classes based on the determined first set of features scores, the predicted first class, and the identified set of confusing class pairs for each datapoint in the received first dataset. Each of the set of semantic classes may be indicative of a prediction accuracy associated with a set of datapoints clustered in corresponding semantic class of the set of semantic classes. The operations may further include training a classifier based on the clustered first dataset, the determined first set of feature scores, and the set of semantic classes.

The objects and advantages of the embodiments will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 is a diagram representing an example environment related to provision of a semantic feedback on a deep neural network (DNN) prediction for decision making;

FIG. 2 is a block diagram of an example system for provision of a semantic feedback on a deep neural network (DNN) prediction for decision making;

FIG. 3 is a flowchart of an example method for provision of a semantic feedback on a deep neural network (DNN) prediction for decision making;

FIG. 4 is a flowchart of an example method for providing a semantic feedback on a prediction result of a Deep Neural Network (DNN) based on a pre-trained classifier;

FIG. 5 is a flowchart of an example method for identification of a set of confusing classes associated with a Deep Neural Network (DNN);

FIGS. 6A and 6B collectively illustrate a flowchart of an example method for clustering of a received first dataset into one of a set of semantic classes for training of a classifier; and

FIG. 7 is an exemplary scenario of a program code of an algorithm for clustering of a received first dataset into one of a set of semantic classes,

all according to at least one embodiment described in the present disclosure.

### DESCRIPTION OF EMBODIMENTS

Deep Neural Networks (DNNs) have achieved a good classification accuracy in various classification tasks, however, in certain applications, such as autonomous driving or medical diagnosis, an incorrect detection or mis-classifications (in even a fraction of cases) may lead to financial or physical losses. This may raise an important concern regarding the reliability of the prediction results of the DNN and regarding the decisions or actions which may be taken based on the prediction results of the DNN. Conventional solutions in the field of explainable artificial intelligence (XAI) may provide an interpretation of the prediction output of the DNN in terms of a set of features that may be used to generate the predicted output of the DNN. Other conventional techniques may involve a use of a native confidence associated with the DNN to quantify a reliability of the prediction output of the DNN. However, the native confidence score may not be readily interpretable to an end user (such as non-technical people) and may not enable the user to take an appropriate decision or an action associated with the prediction result (i.e. confidence score) of the DNN.

Some embodiments described in the present disclosure relate to methods and systems to effectively provide a semantic feedback on a prediction result of a Deep Neural Network (DNN) for decision making. In the present disclosure, a dataset may be clustered into a set of semantic classes based on a first set of feature scores, a class predicted by the DNN, and a set of confusing class pairs for each datapoint in the dataset. Each semantic class may be indicative of a prediction accuracy associated with a set of datapoints clustered in a corresponding semantic class of the set of semantic classes. A classifier may be trained based on the clustered dataset, the first set of features, and the set of semantic classes. In an operational phase, the trained classifier may be used to classify a new datapoint into one of the set of semantic classes based on a second set of feature scores determined for the new datapoint and a class predicted by the DNN for the new datapoint. An action associated with the semantic class (i.e. determined for the new datapoint) may be further determined and the determined action may be rendered for a user to aid the user in appropriate decision making based on the classified semantic class for the new datapoint.

According to one or more embodiments of the present disclosure, the technological field of classification by the DNN may be improved by configuring a computing system in a manner, that the computing system is able to effectively provide a semantic feedback on a prediction result of the DNN which may be understandable by an end user (such as a non-technical person) and may be used for appropriate decision making by the end user. The computing system may include a classifier, which may be trained to cluster a datapoint fed to the DNN into a semantic class indicative of a prediction accuracy of datapoints clustered into the semantic class, as compared to other conventional systems which may not provide user-interpretable feedback on DNN prediction results.

The system may be configured to receive a first dataset associated with a real-time application. Examples of datapoints in the first dataset may include, but are not limited to image data, speech data, audio data, text data, or other forms of digital signals associated with a real-time application. The system may be further configured to control the DNN to predict a first class associated with a first datapoint of the received first dataset, where the a DNN may be pre-trained for a classification task associated with the real-time application. For example, the classification task may be an image classification task and the first datapoint may include an input image of an animal (such as, a cat). The system may be configured to control the DNN to predict the first class (for example, a label of a cat) based on the received first datapoint (for example, the input image of the cat).

The system may be further configured to determine a first set of feature scores for the first datapoint based on the predicted first class associated with the first datapoint. Examples of the first set of feature scores may include at least one of, but not limited to, a Likelihood-based Surprise Adequacy (LSA) score, a Distance-based Surprise Adequacy (DSA) score, a confidence score, a logit score, or a robustness diversity score, for the first datapoint. The LSA score may be indicative of whether the first datapoint is in-distribution with the first dataset. The DSA score may be indicative of whether the first datapoint is closer to the predicted first class than another class neighboring to the predicted first class in a hyper-space associated with the DNN. The confidence score corresponds to a probability score of the DNN for the prediction of the first class associated with the first datapoint. The logit score may correspond to a score from a pre-softmax layer of the DNN for the prediction of the first class associated with the first datapoint. The robustness diversity score may be indicative of a degree of stability of a prediction by the DNN for one or more variations corresponding to the first datapoint.

The system may be further configured to identify a set of confusing class pairs associated with the DNN based on the predicted first class and a predetermined class associated with first datapoint. The system may be further configured to cluster the received first dataset into one of a set of semantic classes based on the determined first set of features scores, the predicted first class, and the identified set of confusing class pairs for each datapoint in the received first dataset. Each of the set of semantic classes may be indicative of a prediction accuracy associated with a set of datapoints clustered in corresponding semantic class of the set of semantic classes. Examples of the set of semantic classes may include at least one of, but not limited to, a likely-correct (or reliably correct) semantic class, a one-of-two semantic class, a likely incorrect semantic class, or a do-not-know semantic class. The system may be further configured to train a classifier based on the clustered first dataset, the determined first set of feature scores, and the set of semantic classes. An example of the classifier may include, but is not limited to, a K-Nearest Neighbor (K-NN) classifier.

For example, in an operational phase, the system may be configured to receive a second datapoint (such as new datapoint) associated with the real-time application. The system may be further configured to control the DNN to predict a second class associated with the second datapoint, where the DNN may be pre-trained for the classification task of the real-time application. The system may be further configured to determine a second set of feature scores for the second datapoint based on the predicted second class associated with the received second datapoint. The second set of feature scores may be similar to the first set of feature scores.

The system may be further configured to apply a pre-trained classifier on the received second datapoint, based on the determined second set of feature scores and the predicted second class. The classifier may be pre-trained to classify a datapoint into one of a set of semantic classes. The system may be further configured to classify the second datapoint into one of the set of semantic classes based on the application of the pre-trained classifier on the second datapoint. The system may be further configured to determine at least one action associated with the classified one of the set of semantic classes for the second datapoint. The system may be further configured to render the determined at least one action for the end user.

Typically, conventional systems may provide an interpretation of a prediction result of the DNN that may not be readily comprehensible by the end user. In other words, interpretation by the conventional systems may not be intuitive for the user to base a decision or action on the interpretation. The disclosed system, on the other hand, may partition an input space of the DNN into various semantic classes that may be human comprehensible. A semantic class may indicate a predictive accuracy of datapoints clustered in the semantic class. The clustering of a datapoint in a certain semantic class may be used to provide the user a qualitative feedback, regarding a reliability of the DNN in the classification of the datapoint and may further enable the user to take an informed decision based on the qualitative feedback (i.e. in form of the semantic class), like how to use or not use the prediction output of the DNN.

Embodiments of the present disclosure are explained with reference to the accompanying drawings.

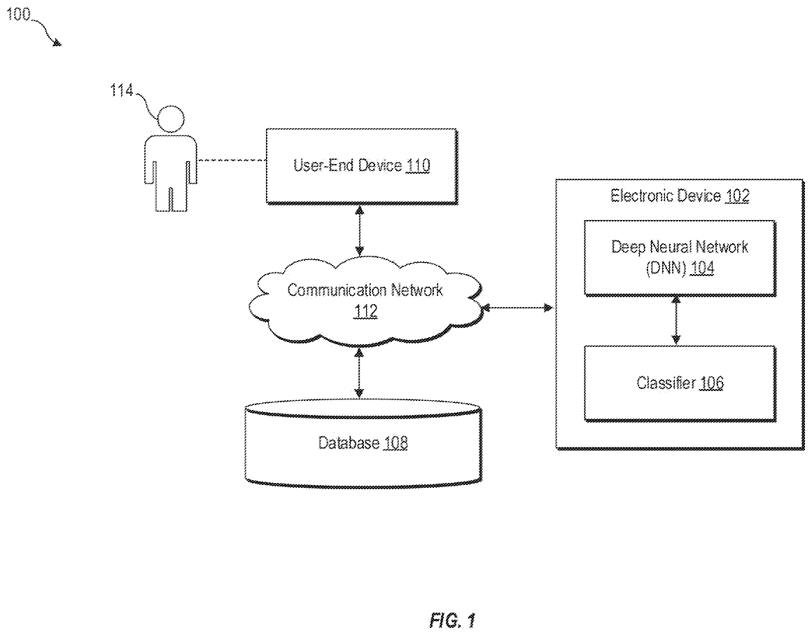

FIG. 1 is a diagram representing an example environment related to provision of a semantic feedback on a deep neural network (DNN) prediction for decision making, arranged in accordance with at least one embodiment described in the present disclosure. With reference to FIG. 1, there is shown an environment 100. The environment 100 may include an electronic device 102. The electronic device may further include a deep neural network (DNN) 104 and a classifier 106. The environment 100 may further include a database 108, a user-end device 110, and a communication network 112. The electronic device 102, the database 108, and the user-end device 110 may be communicatively coupled to each other, via the communication network 112. In FIG. 1, there is further shown a user 114 who may operate or may be associated with the user-end device 110. 100271 The electronic device 102 may comprise suitable logic, circuitry, interfaces, and/or code that may be configured to perform one or more operations for provision of a semantic feedback on a DNN prediction for decision making. In one or more embodiments, the electronic device 102 may be configured to receive a first dataset (which may be stored in the database 108), via the communication network 112. In some embodiments, the electronic device 102 may be configured to store the first dataset in a memory (not shown in FIG. 1) of the electronic device 102. A datapoint in the first dataset may correspond to, but is not limited to, image data, audio data, speech data, or text data. The dataset may correspond to a real-time application for which the DNN 104 may perform a specific classification task. Examples of the real-time application may include, but are not limited to, an image recognition, classification application, a speech recognition application, a text recognition application, a malware detection application, an autonomous vehicle application, an anomaly detection application, a machine translation application, pattern recognition from different digital signals, such as, but not limited to, electrical bio signals, motion data, and depth data.

The electronic device 102 may be configured to control a pre-trained DNN 104 to predict a first class (for example, a label) associated with a first datapoint of the received first dataset. For example, in case the DNN 104 is pre-trained for an image classification task and the first datapoint is an image, the DNN 104 may be controlled to predict an object in the image, such as, an animal (e.g., a cat) as the first class. In some embodiments, the electronic device 102 may control the DNN 104 to generate a first confidence score (i.e. native confidence score as a probability value) which may indicate a prediction for the first class associated with the received first datapoint. Similarly, the electronic device 102 may be configured to control the pre-trained DNN 104 to predict the first class associated with each datapoint in the first dataset.

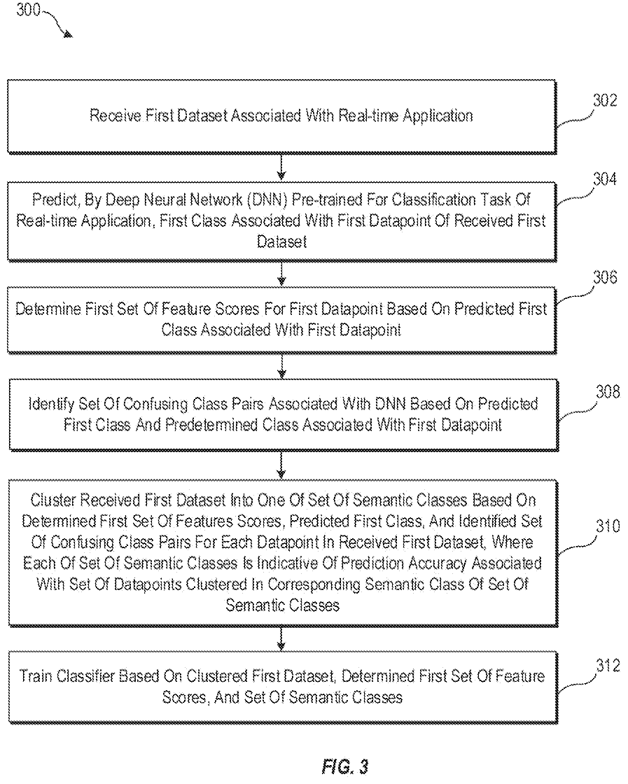

The electronic device 102 may be further configured to determine a first set of features scores for the first datapoint based on the predicted first class associated with the first datapoint. Examples of the first set of feature scores may include at least one of, but not limited to, a Likelihood-based Surprise Adequacy (LSA) score, a Distance-based Surprise Adequacy (DSA) score, a confidence score, a logit score, or a robustness diversity score, for the first datapoint. Details of the first set of feature scores are provided, for example, in FIG. 3.

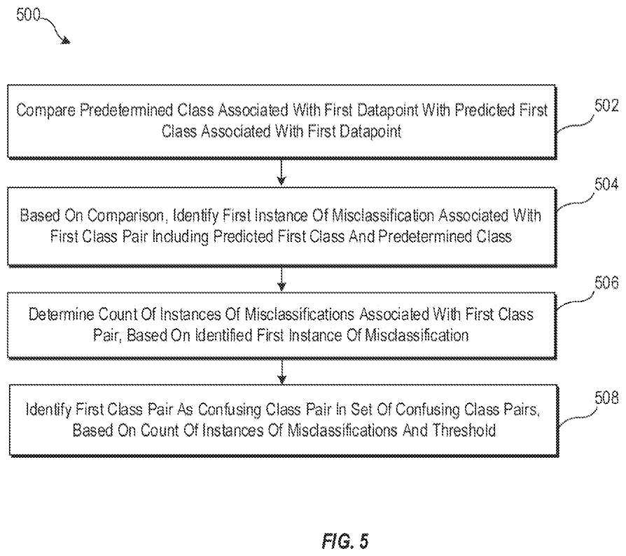

The electronic device 102 may be further configured to identify a set of confusing class pairs associated with the DNN 104 based on the predicted first class and a predetermined class associated with the first datapoint. Similarly, the electronic device 102 may be configured to identify the set of confusing class pairs for each datapoint in the first dataset. The identification of the set of confusing classes for a datapoint is described further, for example, in FIG. 5.

The electronic device 102 may be configured to cluster the received first dataset into one of a set of semantic classes based on the determined first set of features scores, the predicted first class, and the identified set of confusing class pairs for each datapoint in the received first dataset. Each of the set of semantic classes may be indicative of a prediction accuracy associated with a set of datapoints clustered in corresponding semantic class of the set of semantic classes. Examples of the set of semantic classes may include at least one of, but not limited to, a likely-correct semantic class, a one-of-two semantic class, a likely incorrect semantic class, or a do-not-know semantic class. Details of the set of semantic classes are provided, for example, in FIGS. 3, 4, 6A-6B and 7. The electronic device 102 may be further configured to control a training of a classifier (e.g., the classifier 106) based on the clustered first dataset, the determined first set of feature scores, and the set of semantic classes. The training of the classifier (e.g., the classifier 106) for the classification of a datapoint (i.e. input of a pre-trained DNN (e.g., the DNN 104)) into one of the set of semantic classes is described further, for example, in FIGS. 3, 6A, 6B, and 7.

The electronic device 102 may be configured to receive a second datapoint associated with the real-time application, via the communication network 112. The second datapoint may be stored on the database 108 or the user-end device 110. The system may be further configured to control the pre-trained DNN 104 predict a second class (i.e. a label) associated with the second datapoint. The electronic device 102 may be further configured to determine a second set of feature scores for the second datapoint based on the predicted second class associated with the received second datapoint.

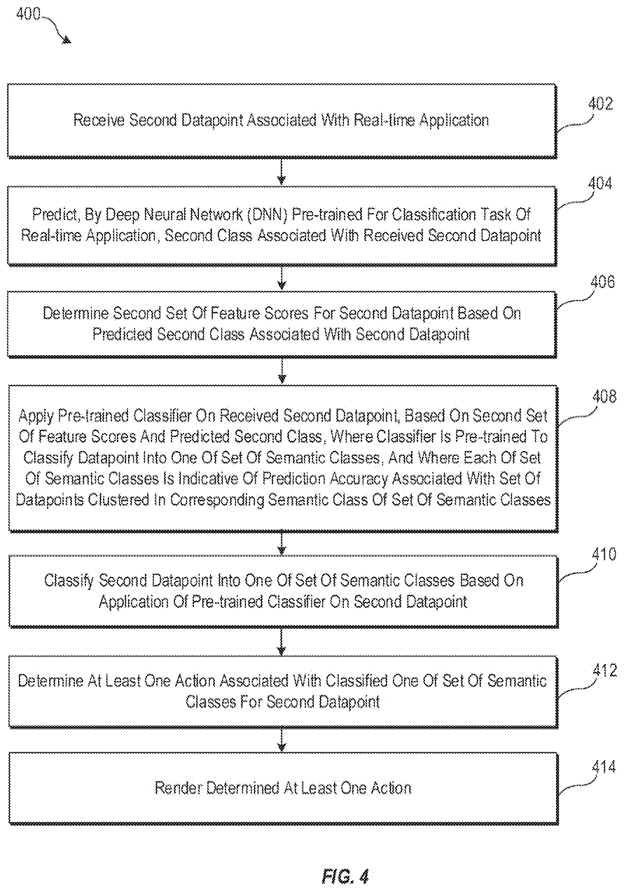

The electronic device 102 may be further configured to apply a pre-trained classifier (e.g., the classifier 106) on the received second datapoint, based on the determined second set of feature scores and the predicted second class. The classifier 106 may be pre-trained to classify a datapoint into one of the set of semantic classes. The electronic device 102 may be further configured to classify the second datapoint into one of the set of semantic classes based on the application of the pre-trained classifier 106 on the second datapoint. The electronic device 102 may be further configured to determine at least one action associated with the classified one of the set of semantic classes for the second datapoint. The electronic device 102 may be further configured to render the determined at least one action for the user 114. The classification of a datapoint into one of the set of semantic classes based on a pre-trained classifier is described further, for example, in FIG. 4.

Examples of the electronic device 102 may include, but are not limited to, an object detection engine, a recognition engine, a mobile device, a desktop computer, a laptop, a computer work-station, a training device, a computing device, a mainframe machine, a server, such as a cloud server, and a group of servers. In one or more embodiments, the electronic device 102 may include a user-end terminal device and a server communicatively coupled to the user-end terminal device. Examples of the user-end terminal device may include, but are not limited to, a mobile device, a desktop computer, a laptop, and a computer work-station. The electronic device 102 may be implemented using hardware including a processor, a microprocessor (e.g., to perform or control performance of one or more operations), a field-programmable gate array (FPGA), or an application-specific integrated circuit (ASIC). In some other instances, the electronic device 102 may be implemented using a combination of hardware and software.

Although in FIG. 1, the classifier 106 and the pre-trained DNN 104 are shown as a part of the electronic device 102; however, in some embodiments, the classifier 106 and the pre-trained DNN 104 may be integrated as a single device, without a deviation from the scope of the disclosure. Alternatively, each of the classifiers 106 and the pre-trained DNN 104 may be implemented within a separate device, without a deviation from the scope of the disclosure.

The DNN 104 may comprise suitable logic, circuitry, interfaces, and/or code that may configured to classify or recognize an input datapoint to generate an output result for the particular real-time application. For example, the pre-trained DNN 104 may recognize different objects in input images and may provide a unique label for each object in the input images. The unique label may correspond to different living (like human, animals, plants) or non-living entities (like, but not limited to, vehicle, building, computer, book, etc.). In another example, the pre-trained DNN 104 related to an application of speech recognition, may recognize different input audio samples to identify a source (e.g., a human-speaker) of the audio sample. In an embodiment, the output unique label may correspond to a prediction result of the DNN 104 for the input datapoint. The DNN 104 may be configured to output a first confidence score (as a native confidence score) which may indicate a probability (between 0 to 1) of the output prediction result of the DNN 104. For example, for the input datapoint as an animal (like cat), the trained DNN 104 may generate a higher first confidence score (for example 0.95 which is close to 1.0) to predict the input datapoint with the unique label as the animal (for example cat). The DNN 104 may be implemented using hardware including a processor, a microprocessor (e.g., to perform or control performance of one or more operations), a field-programmable gate array (FPGA), or an application-specific integrated circuit (ASIC). In some other instances, the DNN 104 may be a code, a program, or set of software instruction. The DNN 104 may be implemented using a combination of hardware and software.

In some embodiments, the DNN 104 may correspond to multiple recognition layers (not shown) for recognition of the input datapoints, where each successive layer may use an output of a previous layer as input. For example, the multiple recognition layer may include an input layer, one or more hidden layers, and an output layer. Each recognition layer may be associated with a plurality of neurons, each of which may be further associated with plurality of weights. During training of the DNN 104, the multiple recognition layers and the plurality of neurons in each layer may be determined from hyper-parameters of the DNN 104. Such hyper-parameters may be set before or while training the DNN 104 on a training dataset (i.e. for example different images of a particular class). The DNN 104 may be trained to adjust the plurality of weights at different layers based on the input datapoints and the output result (i.e. a ground truth) of the DNN 104.

Each neuron or node of the DNN 104 may correspond to a mathematical function (e.g., a sigmoid function or a rectified linear unit) with a set of parameters, tunable to train the DNN 104 for the relationship between the first datapoint (for example an image data), as the input of the DNN 104, and the prediction result or class as the output of the DNN 104. The set of parameters may include, for example, a weight parameter, a regularization parameter, and the like. Each neuron may use the mathematical function to compute an output based on one or more inputs from neurons in other layer(s) (e.g., previous layer(s)) of the DNN 104. All or some of the neurons of the DNN 104 may correspond to same or a different mathematical function.

In training of the DNN 104, one or more parameters (like weights) of each neuron of the DNN 104 may be updated based on whether an output of the final layer for a given input (from the training dataset) matches a correct result based on a loss function for the DNN. This update process may be repeated for same or a different input till a minima of loss function may be achieved and a training error may be minimized. Several methods for training the DNN are known in art, for example, gradient descent, stochastic gradient descent, batch gradient descent, gradient boost, meta-heuristics, and the like. The DNN 104 may include code and routines configured to enable a computing device, such as the electronic device to perform one or more operations for classification of one or more data inputs (i.e. for example image data) into one or more outputs (i.e. class labels).

Examples of the DNN 104 may include, but are not limited to, a recurrent neural network (RNN), an artificial neural network (ANN), a convolutional neural network (CNN), a CNN-recurrent neural network (CNN-RNN), R-CNN, Fast R-CNN, Faster R-CNN, a Long Short Term Memory (LSTM) network based RNN, CNN+ANN, LSTM+ANN, a gated recurrent unit (GRU)-based RNN, a fully connected neural network, a Connectionist Temporal Classification (CTC) based RNN, a deep Bayesian neural network, a Generative Adversarial Network (GAN), and/or a combination of such networks.

The classifier 106 may comprise suitable logic, circuitry, interfaces, and/or code that may configured to classify an input datapoint into one of the set of semantic classes. Each of the set of semantic classes may be indicative of a prediction accuracy associated with a set of datapoints clustered in corresponding semantic class of the set of semantic classes. Examples of the set of semantic classes may include at least one of, but not limited to, a likely-correct semantic class, a one-of-two semantic class, a likely-incorrect semantic class, or a do-not-know semantic class. The classifier 106 may be pre-trained, by the electronic device 102, based on the clustered first dataset, the determined first set of feature scores, and the set of semantic classes for each datapoint in the first dataset related to the real-time application. The training of the classifier 106 is described, for example, in FIGS. 3, 6A, 6B, and 7. Examples of the set of the classifiers 106 may include, but are not limited to, k-nearest neighbor (K-NN) classifier, a decision tree classifier, a Support Vector Machine (SVM) classifier, a Naïve Bayes classifier, or a Logistic Regression classifier.

The database 108 may comprise suitable circuitry, logic, interfaces, and/or code that may be configured to store a dataset (e.g., the first dataset) including a plurality of datapoints related to the real-time application. The electronic device 102 may receive the first dataset from the database 108. Further, the plurality of datapoints in the first dataset may be a set of training datapoints (or a training dataset) that may be used to train the DNN 104 and/or the classifier 106. The plurality of datapoints may further include a set of test datapoints (or a test dataset) which may be used to test the DNN 104 or test the classifier 106. The database 108 may be a relational or a non-relational database that include the training dataset or the test dataset. Also, in some cases, the database 108 may be stored on a server, such as a cloud server or may be cached and stored on the electronic device 102. The server of the database 108 may be configured to receive a request to provide a dataset (e.g., the first dataset) or a new datapoint (e.g., the second datapoint) from the electronic device 102, via the communication network 112. In response, the server of the database 108 may be configured to retrieve and provide the requested dataset or a particular datapoint to the electronic device 102 based on the received request, via the communication network 112. In some embodiments, the database 108 may be configured to store the classifier 106. In some embodiments, the database 108 may be configured to store the pre-trained DNN 104 for the particular real-time applications. Additionally, or alternatively, the database 108 may be implemented using hardware including a processor, a microprocessor (e.g., to perform or control performance of one or more operations), a field-programmable gate array (FPGA), or an application-specific integrated circuit (ASIC). In some other instances, the database 108 may be implemented using a combination of hardware and software.

The user-end device 110 may comprise suitable logic, circuitry, interfaces, and/or code that may be configured to store the real-time application where the specific classification task (i.e. for which the DNN 104 and the classifier 106 are trained) may be performed. In some embodiments, the user-end device 110 may deploy the pre-trained DNN 104 and the classifier 106 to provide a semantic feedback on the prediction results of the deployed pre-trained DNN 104. The user-end device 110 may utilize the deployed DNN 104 to perform the classification or detection task of the real-time application, train the classifier 106, and utilize the deployed classifier 106 for the determination of the semantic feedback (i.e. set of semantic classes) on the prediction or classification result generated by the deployed DNN 104. For example, the user-end device 110 may be an electronic device which may receive an input image from an in-built camera or a server and may perform the image classification or recognition on the input image based on the trained DNN 104 deployed on the user-end device 110. The user-end device 110 may train the classifier 106 and further use the deployed trained classifiers 106 to determine the semantic feedback on a reliability of classification of the image (i.e. the predicted image class) performed by the DNN 104 (i.e. deployed on the user-end device 110). In another example, the user-end device 110 may be an autonomous vehicle which may receive real-time images from surrounding and detect different objects captured in the images through in-built trained DNN 104. In such scenario, the user-end device 110 may use the pre-trained classifier 106 to determine the semantic feedback (i.e. the set of semantic classes) on the prediction output of the DNN 104, and indicate or warn about a potential mis-judgement or incorrect detection, performed by the DNN 104 of the autonomous vehicle, to a user associated with the autonomous vehicle. In some embodiments, the user-end device 110 may take appropriate actions (for example apply brakes or control steering of the autonomous vehicle) based on the incorrection detection or mis-judgement performed by the DNN 104, deployed in the autonomous vehicle.

In another example, the user-end device 110 may be audio security system which may perform user authentication based on speech recognition performed by the DNN 104 trained on different speech data samples. Similarly, the user-end device 110 may validate the authentication of the user performed by the DNN 104, by use of the trained classifier 106 to validate the accuracy of authentication, using the set of semantic classes. It should be noted here that the aforementioned examples are not be construed as limiting for the disclosure, and the DNN 104 may be used many possible applications which have not been mentioned for the sake of brevity. Examples of the user-end device 110 may include, but are not limited to, a mobile device, a desktop computer, a laptop, a computer work-station, a computing device, a mainframe machine, a server, such as a cloud server, and a group of servers.

The communication network 112 may include a communication medium through which the electronic device 102 may communicate with the server which may store the database 108 and the user-end device 110. Examples of the communication network 112 may include, but are not limited to, the Internet, a cloud network, a Wireless Fidelity (Wi-Fi) network, a Personal Area Network (PAN), a Local Area Network (LAN), and/or a Metropolitan Area Network (MAN). Various devices in the environment 100 may be configured to connect to the communication network 112, in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), ZigBee, EDGE, IEEE 802.11, light fidelity(Li-Fi), 802.16, IEEE 802.11s, IEEE 802.11g, multi-hop communication, wireless access point (AP), device to device communication, cellular communication protocols, and/or Bluetooth (BT) communication protocols, or a combination thereof.

Modifications, additions, or omissions may be made to FIG. 1 without departing from the scope of the present disclosure. For example, the environment 100 may include more or fewer elements than those illustrated and described in the present disclosure. For instance, in some embodiments, the environment 100 may include the electronic device 102 but not the database 108 and the user-end device 110. In addition, in some embodiments, the functionality of each of the database 108 and the user-end device 110 may be incorporated into the electronic device 102, without a deviation from the scope of the disclosure.

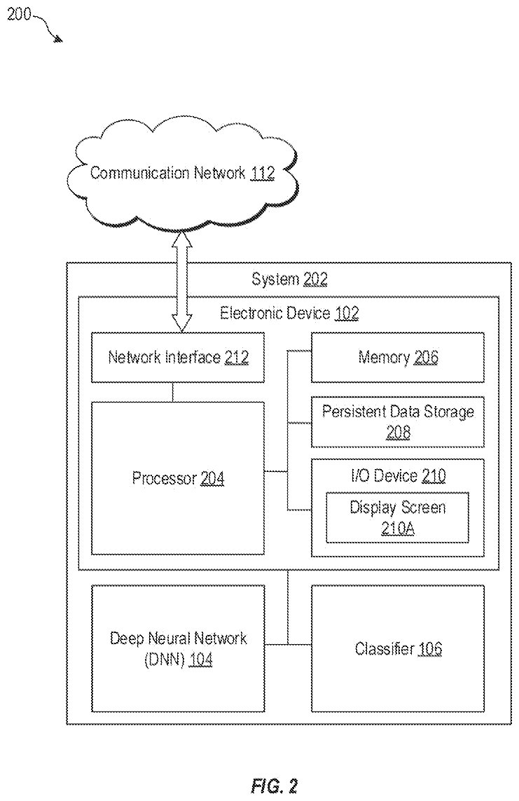

FIG. 2 is a block diagram of an example system for provision of a semantic feedback on a deep neural network (DNN) prediction for decision making, arranged in accordance with at least one embodiment described in the present disclosure. FIG. 2 is explained in conjunction with elements from FIG. 1. With reference to FIG. 2, there is shown a block diagram 200 of an example system 202. The example system 202 may include the electronic device 102, the DNN 104, and the classifier 106. The electronic device 102 may include a processor 204, a memory 206, a persistent data storage 208, an input/output (I/O) device 210, and a network interface 212. The I/O device 210 may further include a display screen 210A.

The processor 204 may comprise suitable logic, circuitry, and/or interfaces that may be configured to execute program instructions associated with different operations to be executed by the electronic device 102. For example, some of the operations may include reception of the first dataset, control of the DNN 104 for the prediction of the first class associated with the first datapoint in the received first dataset, determination of the first set of feature scores for the first datapoint, identification of the set of confusing class pairs, clustering of the received first dataset, and the training of the classifier 106. The one or more operations may further include reception of the second datapoint, control of the DNN 104 for the prediction of the second class associated with the second datapoint, determination of the second set of features for the second datapoint, application of the trained classifier 106 on the second datapoint, and classification of the second datapoint into one of the set of semantic classes. The processor 204 may include any suitable special-purpose or general-purpose computer, computing entity, or processing device including various computer hardware or software modules and may be configured to execute instructions stored on any applicable computer-readable storage media. For example, the processor 204 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 2, the processor 204 may include any number of processors configured to, individually or collectively, perform or direct performance of any number of operations of the electronic device 102, as described in the present disclosure. Additionally, one or more of the processors may be present on one or more different electronic devices, such as different servers.

In some embodiments, the processor 204 may be configured to interpret and/or execute program instructions and/or process data stored in the memory 206 and/or the persistent data storage 208. In some embodiments, the processor 204 may fetch program instructions from the persistent data storage 208 and load the program instructions in the memory 206. After the program instructions are loaded into the memory 206, the processor 204 may execute the program instructions. Some of the examples of the processor 204 may be a GPU, a CPU, a RISC processor, an ASIC processor, a CISC processor, a co-processor, and/or a combination thereof.

The memory 206 may comprise suitable logic, circuitry, interfaces, and/or code that may be configured to store program instructions executable by the processor 204. In certain embodiments, the memory 206 may be configured to store operating systems and associated application-specific information. The memory 206 may include computer-readable storage media for carrying or having computer-executable instructions or data structures stored thereon. Such computer-readable storage media may include any available media that may be accessed by a general-purpose or special-purpose computer, such as the processor 204. By way of example, and not limitation, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store particular program code in the form of computer-executable instructions or data structures, and which may be accessed by a general-purpose or special-purpose computer. Combinations of the above may also be included within the scope of computer-readable storage media. Computer-executable instructions may include, for example, instructions and data configured to cause the processor 204 to perform a certain operation or group of operations associated with the electronic device 102.

The persistent data storage 208 may comprise suitable logic, circuitry, and/or interfaces that may be configured to store program instructions executable by the processor 204, operating systems, and/or application-specific information, such as logs and application-specific databases. The persistent data storage 208 may include computer-readable storage media for carrying or having computer-executable instructions or data structures stored thereon. Such computer-readable storage media may include any available media that may be accessed by a general-purpose or special-purpose computer, such as the processor 204.

By way of example, and not limitation, such computer-readable storage media may include tangible or non-transitory computer-readable storage media including Compact Disc Read-Only Memory (CD-ROM) or other optical disk storage, magnetic disk storage or other magnetic storage devices (e.g., Hard-Disk Drive (HDD)), flash memory devices (e.g., Solid State Drive (SSD), Secure Digital (SD) card, other solid state memory devices), or any other storage medium which may be used to carry or store particular program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 204 to perform a certain operation or group of operations associated with the electronic device 102.

In some embodiments, either of the memory 206, the persistent data storage 208, or combination may store the classifier 106 and the DNN 104 as software instructions. The processor 204 may fetch the software instructions related to the classifier 106 and the DNN 104 to perform different operations of the disclosed electronic device 102. In some embodiments, either of the memory 206, the persistent data storage 208, or combination may store the first dataset, second datapoint, the training/test dataset, the first set of features, the predicted first class, and/or the set of datapoints clustered in the set of semantic classes.

The I/O device 210 may include suitable logic, circuitry, interfaces, and/or code that may be configured to receive a user input. The I/O device 210 may be further configured to provide an output in response to the user input. For example, I/O device 210 may receive a command (e.g., through a user-interface), a voice instruction, or a handwritten text as a user input from a user, where the received user input may be used to initiate the training of the DNN 104, training of the classifiers 106, or to provide the semantic feedback (i.e. one of the set of semantic classes) on the prediction result of the trained DNN 104. The I/O device 210 may include various input and output devices, which may be configured to communicate with the processor 204 and other components, such as the network interface 212. The I/O device 210 may include an input device or an output device. Examples of the input device may include, but are not limited to, a touch screen (e.g., the display screen 210A), a keyboard, a mouse, a joystick, and/or a microphone. Examples of the output device may include, but are not limited to, a display (e.g., the display screen 210A) and a speaker.

The display screen 210A may comprise suitable logic, circuitry, interfaces, and/or code that may be configured to display the semantic class in which a datapoint may be classified by the classifier 106. Further, the display screen 210A may be configured to render an action associated with the classified semantic class. The display screen 210A may be configured to receive the user input from the user 114. In such cases the display screen 210A may be a touch screen to receive the user input. The display screen 210A may be realized through several known technologies such as, but not limited to, a Liquid Crystal Display (LCD) display, a Light Emitting Diode (LED) display, a plasma display, and/or an Organic LED (OLED) display technology, and/or other display technologies.

The network interface 212 may comprise suitable logic, circuitry, interfaces, and/or code that may be configured to establish a communication between the electronic device 102, the database 108, and the user-end device 110, via the communication network 112. The network interface 212 may be implemented by use of various known technologies to support wired or wireless communication of the electronic device 102 via the communication network 112. The network interface 212 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, and/or a local buffer.

The network interface 212 may communicate via wireless communication with networks, such as the Internet, an Intranet and/or a wireless network, such as a cellular telephone network, a wireless local area network (LAN) and/or a metropolitan area network (MAN). The wireless communication may use any of a plurality of communication standards, protocols and technologies, such as Global System for Mobile Communications (GSM), Enhanced Data GSM Environment (EDGE), wideband code division multiple access (W-CDMA), Long Term Evolution (LTE), code division multiple access (CDMA), time division multiple access (TDMA), Bluetooth, Wireless Fidelity (Wi-Fi) (such as IEEE 802.11a, IEEE 802.11b, IEEE 802.11g and/or IEEE 802.11n), voice over Internet Protocol (VoIP), light fidelity (Li-Fi), or Wi-MAX.

Modifications, additions, or omissions may be made to the example system 202 without departing from the scope of the present disclosure. For example, in some embodiments, the example system 202 may include any number of other components that may not be explicitly illustrated or described for the sake of brevity. In an example, the DNN 104 and the classifier 106 may be integrated in the electronic device 102 as shown in FIG. 1.

FIG. 3 is a flowchart of an example method for provision of a semantic feedback on a deep neural network (DNN) prediction for decision making, according to at least one embodiment described in the present disclosure. FIG. 3 is explained in conjunction with elements from FIG. 1 and FIG. 2. With reference to FIG. 3, there is shown a flowchart 300. The method illustrated in the flowchart 300 may start at 302 and may be performed by any suitable system, apparatus, or device, such as the example electronic device 102 of FIG. 1 or the example system 202 of FIG. 2. For example, one or more of the electronic device 102, or the pre-trained DNN 104 may perform one or more of the operations associated with the method 300. Although illustrated with discrete blocks, the steps and operations associated with one or more of the blocks of the method 300 may be divided into additional blocks, combined into fewer blocks, or eliminated, depending on the particular implementation.

At block 302, a first dataset may be received. The first dataset may be associated with a real-time application. The first dataset may include a plurality of datapoints including a first datapoint. For example, the first datapoint may include, but is not limited to, an image, audio/speech samples, text characters, software instructions, or other forms of digital signals, such as but not limited to, electrical bio-signals, motion data, or depth data. Examples of the real-time applications may include, but are not limited to, an image recognition application, an image classification application, a speech recognition application, a text recognition application, a malware detection application, an autonomous vehicle application, an anomaly detection application, a machine translation application, or pattern recognition application from digital signals/data.

In some embodiments, the processor 204 may be configured to receive the first dataset (for example, a set of images) that may be stored in either or combination of the memory 206, the persistent data storage 208, or the database 108. The first datapoint (for example, an image) of the first dataset may be received for classification or prediction into a particular class label, where the classification or prediction may be performed by the pre-trained DNN 104.

At block 304, a first class associated with the first datapoint of the received first datapoint may be predicted. The pre-trained DNN 104 may be controlled to predict the first class associated with the received first datapoint. In one or more embodiments, the processor 204 may be configured to control the pre-trained DNN 104 to predict the first class for the received first datapoint. For example, in case the DNN 104 is pre-trained for image classification tasks and the first datapoint is an image, the pre-trained DNN 104 may predict the first class as a living object (e.g., an animal, plant, or a human) or a non-living object (e.g., a building, a vehicle, a street, a symbol, or any other object) for the image. In case, the image input to the DNN 104 is of a dog animal, then the DNN 104 may output a unique class label which may indicate the classification of the image into a dog label. The output class label may be considered as the prediction result of the DNN 104.

The DNN 104 may be configured to generate a first confidence score, as a native confidence score, of the DNN 104. The first confidence score may indicate a probability value (say between 0 to 1) to indicate the prediction result of the DNN 104. In other words, the first confidence score generated by the DNN 104 may indicate the prediction of the first class (i.e. class label) for the received input image (or the datapoint). Similarly, the processor 204 may control the pre-trained DNN 104 to predict the first class associated with each datapoint in the received first dataset.

At block 306, a first set of feature scores may be determined for the first datapoint based on the predicted first class associated with the first datapoint. In one or more embodiments, the processor 204 may be configured to determine the first set of feature scores for the first datapoint based on the predicted first class associated with the first datapoint. Examples of the first set of feature scores may include at least one of, but not limited to, a Likelihood-based Surprise Adequacy (LSA) score, a Distance-based Surprise Adequacy (DSA) score, a confidence score, a logit score, or a robustness diversity score, for the first datapoint. Determination of surprise adequacy based scores is described next. For example, let N={n₁, n₂, . . . } be a set of neurons associated with the DNN 104, and let X={x₁, x₂, . . . } be a set of datapoints in the received first dataset. An activation value of a neuron n with respect to a datapoint x (e.g., the first datapoint) may be represented as αₙ(x). A vector of activation values may be represented as α_{N}(x), for an ordered sub-set of neurons (i.e., N⊂N). The term α_{N}(x) is referred herein as an Activation Trace (AT) of x (i.e., the first datapoint) over the neurons in N. Similarly, a set of activation traces that may be observed over the neurons in N, for the set of datapoints X (i.e., the received first dataset) may be represented as A_{N}(X)={α_{N}(x)|x∈X}. For a training dataset (e.g., a dataset T) of the DNN 104, the processor 204 may determine a set of activation traces over all neurons in N for each datapoint in the training dataset T. Such determined set of activation traces for the training dataset may be represented by A_{N}(T). For a new datapoint x (e.g., the first datapoint), the processor 204 may determine a degree of surprise associated with the new datapoint x (i.e., the first datapoint) with respect to the training dataset (i.e., the dataset T) based on a comparison of αₙ(x) for the new datapoint x (i.e., the first datapoint) and A_{N}(T) for the training dataset T. The degree of surprise is referred herein as a Surprise Adequacy score. In the present disclosure, the training dataset may correspond to the first dataset itself, of which the first datapoint may be a part. Thus, the processor 204 may determine the Surprise Adequacy score for the first datapoint (which may be represented as x) with respect to the first dataset (which may be represented as X, where x∈X), based on a comparison of αₙ(x) for the first datapoint and A_{N}(X) for the first dataset.

The Likelihood-based Surprise Adequacy (LSA) score may be indicative of whether the first datapoint is in-distribution with the first dataset. In an example, the LSA score may be determined based on a Kernel Density Estimation (KDE) technique that may estimate a probability density function of a random variable such that the estimated probability density function may enable estimation of a relative likelihood of a certain value of the random variable. For example, the KDE technique may be used to determine the LSA score associated with the first datapoint by estimation of a probability density of each activation value in A_{N}(X) and determination of a degree of surprise (i.e., a Surprise Adequacy score) of the first datapoint with respect to the estimated probability density.

The Distance-based Surprise Adequacy (DSA) score may be indicative of whether the first datapoint is closer to the predicted first class than another class neighboring to the predicted first class in a hyper-space associated with the DNN 104. For example, the DSA score associated with the first datapoint may be determined based on a distance between Activation Traces (ATs) as a degree of surprise (i.e., a Surprise Adequacy score). The DSA score associated with the first datapoint may be determined based on a Euclidean distance between the Activation Trace (AT) of the first datapoint and Activation Traces (ATs) associated with each datapoint in the first dataset. As an example, let C represent a set of classes associated with the DNN 104, A_{N}(X) represent the set of Activation Traces associated with the first dataset, x represent the first datapoint, and cₓ (where cₓ∈C) represent the predicted first class associated with the first datapoint x. The processor 204 may determine a reference datapoint (e.g., xₐ) in the first dataset that may be a nearest neighbor of the first datapoint (i.e., x) and may be associated with the same first class cₓ. Herein, an activation trace (e.g., α_{N}(xₐ)) of the reference datapoint (i.e., xₐ) may have a nearest Euclidean distance to the activation trace (e.g., α_{N}(x)) of the first datapoint (i.e., x) than other datapoints in the first dataset that may associated with first class (i.e., cₓ). Let the Euclidean distance between the activation trace (e.g., α_{N}(xₐ)) of the reference datapoint (i.e., xₐ) and the activation trace (e.g., α_{N}(x)) of the first datapoint (i.e., x) may be represented by distₐ. The processor 204 may further determine a datapoint (e.g., x_{b}) that may be closest neighbor of the reference datapoint (i.e., xₐ) and may be associated with a class other than the first class (i.e., cₓ). The processor 204 may determine a Euclidean distance (e.g., dist_{b}) between the activation trace (e.g., α_{N}(xₐ)) of the reference datapoint (i.e., xₐ) and an activation trace (e.g., α_{N}(x_{b})) of the datapoint x_{b}. In an example, the processor 204 may determine the DSA score associated with the first datapoint based on a ratio of distₐ and dist_{b}, i.e., distₐ/dist_{b}.

The confidence score may correspond to a probability score of the DNN 104 for the prediction of the first class associated with the first datapoint. In other words, the confidence score may be a probability determined by the DNN 104 that the first class predicted by the DNN 104 for the first datapoint is accurate. The logit score may correspond to a score from a pre-softmax layer of the DNN 104 for the prediction of the first class associated with the first datapoint. The logit score may be an un-normalized score associated with the prediction output of the DNN 104 that may be obtained from the pre-softmax layer. A higher logit score for the first class associated with the first datapoint may be indicative that the prediction of the DNN 104 for the first datapoint is accurate.

The robustness diversity score may be indicative of a degree of stability of a prediction by the DNN 104 for one or more variations corresponding to the first datapoint. In an embodiment, the processor 204 may determine a set of variations of the first datapoint based on application of one or more variations on the first datapoint. The robustness diversity score may be determined based on a ratio of a number of variations that may be accurately predicted by the DNN 104 to the total number of variations in the set of variations. For example, in case the first datapoint is an image of a cat, the processor 204 may determine the set of variations based on application of one or more rotation variations on the first datapoint. By application of the one or more rotation variations may obtain one or more first images in which the cat may be rotated by different angles. Similarly, the processor 204 may apply one or more translation variations and/or one or more scaling variations on the first datapoint to obtain one or more second images and/or one or more third images, respectively. The set of variations of the first datapoint may be obtained as a collection of the one or more first images, the one or more second images, and the one or more third images. Similarly, the processor 204 may determine different variations, such as a zoom variation, a brightness variation, a contrast variation, a color variation, a flip variation, a sharpness variation, or a shear variation to determine different datapoints for the first datapoint of the first dataset. In an embodiment, the processor 204 may further control the DNN 104 to predict a class associated with each of the set of variations of the first datapoint. Thereafter, the processor 204 may determine a ratio of a number of variations for which the first class is accurately predicted to the total number of variations in the set of variations may be determined. The robustness diversity score may be determined based on the ratio of accurately predicted variations (i.e., the variations for which the first class is correctly predicted by the DNN 104) to the total number of variations in the set of variations. Thus, based on the ratio, the robustness diversity score may indicate the degree of stability of the prediction by the DNN 104 for different variations applied to the first datapoint. Similarly, the processor 204 may be configured to determine the first set of features (i.e., the LSA score, the DSA score, the confidence score, the logit score, and the robustness diversity score) for each datapoint in the first dataset.

At block 308, a set of confusing class pairs associated with the DNN 104 may be identified based on the predicted first class and a predetermined class associated with the first datapoint. In one or more embodiments, the processor 204 may be configured to identify the set of confusing class pairs associated with the DNN 104 based on the predicted first class and the predetermined class associated with the first datapoint. The predetermined class may correspond to a ground truth or expected class for the first datapoint. Similarly, the electronic device 102 may be configured to identify the set of confusing class pairs for each datapoint in the first dataset. The identification of the set of confusing classes for a datapoint is described further, for example, in FIG. 5.

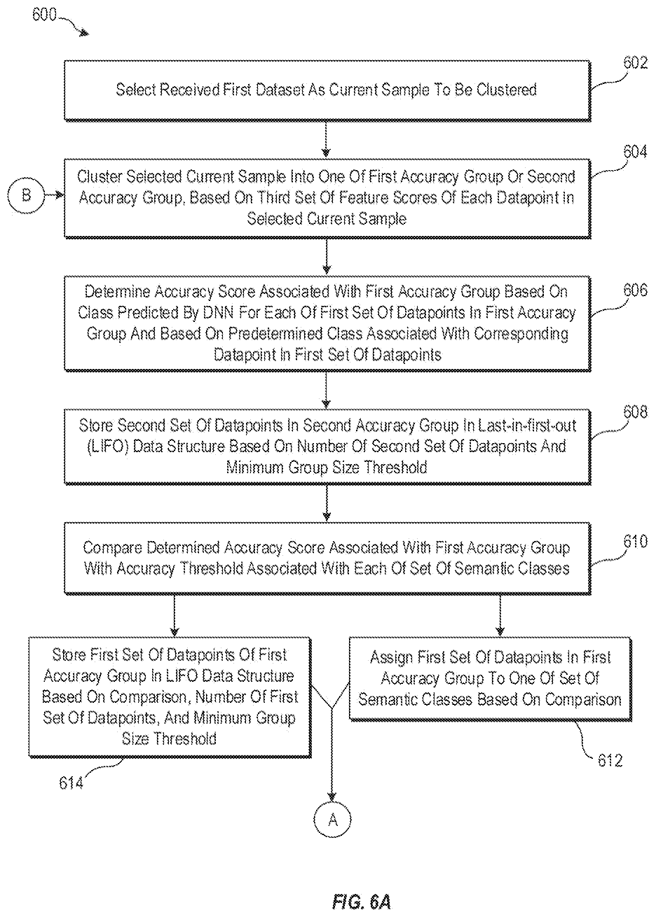

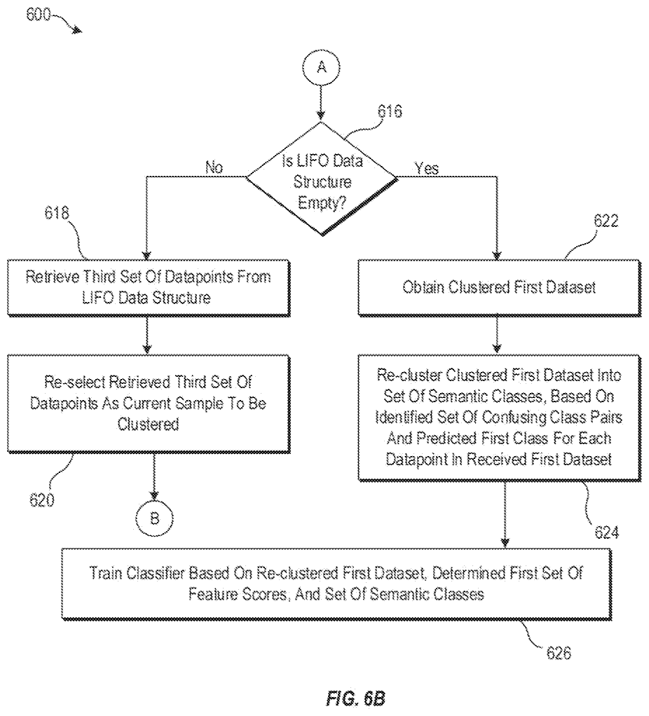

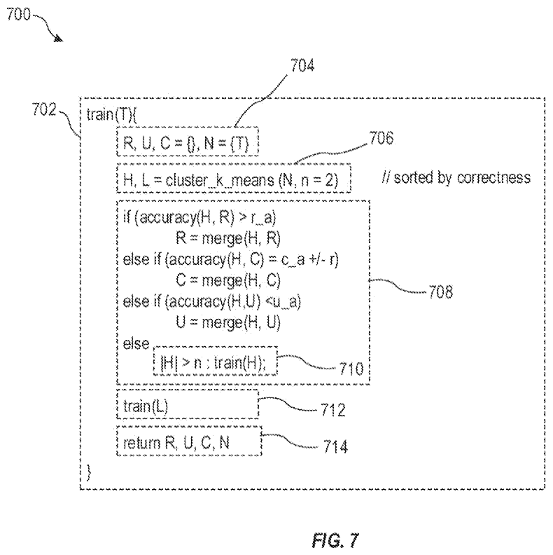

At block 310, the received first dataset may be clustered into one of a set of semantic classes based on the determined first set of features, the predicted first class, and the identified set of confusing class pairs for each datapoint in the received first dataset. Each of the set of semantic classes may be indicative of a prediction accuracy associated with a set of datapoints clustered in corresponding semantic class of the set of semantic classes. The prediction accuracy associated with the set of semantic classes is described further, for example, in FIGS. 6A, 6B, and 7. In one or more embodiments, the processor 204 may be configured to cluster the received first dataset into one of the set of semantic classes based on the determined first set of features scores, the predicted first class, and the identified set of confusing class pairs for each datapoint in the received first dataset. Examples of the set of semantic classes may include at least one of, but not limited to, a likely-correct (or reliably correct) semantic class, a one-of-two semantic class, a likely-incorrect semantic class, or a do-not-know semantic class. The clustering of the received first dataset into one of the set of semantic classes is described further, for example, in FIGS. 6A, 6B, and 7.

At block 312, the classifier 106 may be trained based on the clustered first dataset, the determined first set of features, and the set of semantic classes. In one or more embodiments, the processor 204 may be configured to control a training of a classifier (e.g., the classifier 106 or a meta-classifier) based on the clustered first dataset, the determined first set of feature scores, and the set of semantic classes. Examples of the classifier 106 may include, but are not limited to, a decision tree classifier, a Support Vector Machine (SVM) classifier, a Naïve Bayes classifier, a Logistic Regression classifier, or a k-nearest neighbor (K-NN) classifier. In an example, the classifier 106 may be built and trained as a K-NN classifier with K=5 nearest neighbors. As an example, a Scikit-Learn library may be used to build and train the K-NN classifier. Based on the training of the K-NN classifier (e.g., the classifier 106), the K-NN classifier may output the set of confusing class pairs associated with the DNN 104.

In an embodiment, the processor 204 may control the training of the classifier 106 based on a relationship between the first set of features scores associated with each datapoint in the first dataset and a semantic class of the set of semantic classes in which each datapoint in the first dataset may be clustered. In an example, the likely-correct semantic class may be a semantic class with datapoints that may be in-distribution with the training data (i.e., the first dataset). Further, in the likely-correct semantic class, a confidence associated with a prediction by the DNN 104 for associated datapoints may be high and the prediction for such datapoints may not be confusing. In addition, the prediction by the DNN 104 for such datapoints may be robust to variations in the datapoints clustered in the likely-correct semantic class. In another example, the one-of-two semantic class may be a semantic class with clustered datapoints, such that a prediction by the DNN 104 for such datapoints may have two equally likely classes with a similar confidence. Further, the prediction by the DNN 104 for such datapoints may not be robust. In yet another example, the likely-incorrect class may be a semantic class with clustered datapoints that may be severely out of distribution with the training data (i.e., the first dataset). Further, a confidence associated with a prediction by the DNN 104 for such datapoints may be low. In addition, the prediction by the DNN 104 for such datapoints may not be robust to variations in the datapoints clustered in the likely-incorrect class. In another example, the do-not-know semantic class may be a semantic class that may include datapoints of the first dataset that may remain after the clustering of the first dataset into the likely-correct semantic class, the one-of-two semantic class, and the likely-incorrect semantic class. The training of the classifier (e.g., the classifier 106) for the classification of a datapoint (i.e. input to a pre-trained DNN (e.g., the DNN 104)) into one of the set of semantic classes is described further, for example, in FIGS. 6A, 6B, and 7. The control may pass to end.

Although the flowchart 300 is illustrated as discrete operations, such as 302, 304, 306, 308, 310, and 312. However, in certain embodiments, such discrete operations may be further divided into additional operations, combined into fewer operations, or eliminated, depending on the particular implementation without detracting from the essence of the disclosed embodiments.

FIG. 4 is a flowchart of an example method for providing a semantic feedback on a prediction result of a Deep Neural Network (DNN) based on a pre-trained classifier, according to at least one embodiment described in the present disclosure. FIG. 4 is explained in conjunction with elements from FIG. 1, FIG. 2, and FIG. 3. With reference to FIG. 4, there is shown a flowchart 400. The method illustrated in the flowchart 400 may start at 402 and may be performed by any suitable system, apparatus, or device, such as by the example electronic device 102 of FIG. 1 or the example system 202 of FIG. 2. For example, one or more of the electronic device 102 or a classifier (e.g., the classifier 106) may perform one or more of the operations associated with the method 400. Although illustrated with discrete blocks, the steps and operations associated with one or more of the blocks of the method 400 may be divided into additional blocks, combined into fewer blocks, or eliminated, depending on the particular implementation.

At block 402, a second datapoint may be received. The second datapoint may be associated with a real-time application. For example, the second datapoint may include, but is not limited to, an image, audio/speech samples, text characters, software instructions, or other forms of digital signals, such as but not limited to, electrical bio-signals, motion data, or depth data. Examples of the real-time applications may include, but are not limited to, an image recognition application, an image classification application, a speech recognition application, a text recognition application, a malware detection application, an autonomous vehicle application, an anomaly detection application, a machine translation application, or pattern recognition application from digital signals/data.

In some embodiments, the processor 204 may be configured to receive the second datapoint (for example, an image) that may be stored in either or combination of the memory 206, the persistent data storage 208, or the database 108. The second datapoint (for example, the image) may be received for classification or prediction into a particular class label, where the classification or prediction may be performed by the pre-trained DNN 104. In an embodiment, the second datapoint may be a new datapoint which may not be included in the training dataset (i.e. first dataset) of the trained DNN 104.

At block 404, a second class associated with the received second datapoint may be predicted. The pre-trained DNN 104 may be controlled to predict the second class associated with the received second datapoint. In one or more embodiments, the processor 204 may be configured to control the pre-trained DNN 104 to predict the second class for the received second datapoint. For example, in case the DNN 104 is pre-trained for image classification tasks and the second datapoint is an image, the pre-trained DNN 104 may predict the second class as a living object (e.g., an animal, plant, or a human) or a non-living object (e.g., a building, a vehicle, a street, a symbol, or any other object) for the image. In case, the image input to the DNN 104 is of a dog animal, then the DNN 104 may output a unique class label which may indicate the classification of the image into a dog label. The output class label may be considered as the prediction result of the DNN 104. The DNN 104 may be configured to generate a second confidence score, as a native confidence score, of the DNN 104. The second confidence score may indicate a probability value (say between 0 to 1) to indicate the prediction result of the DNN 104. In other words, the second confidence score generated by the DNN 104 may indicate the prediction of the second class (i.e. class label) for the received input image (or the datapoint).

At block 406, a second set of feature scores may be determined for the second datapoint based on the predicted second class associated with the second datapoint. In one or more embodiments, the processor 204 may be configured to determine the second set of feature scores for the second datapoint based on the predicted second class associated with the second datapoint. Examples of the second set of feature scores may include at least one of, but not limited to, a Likelihood-based Surprise Adequacy (LSA) score, a Distance-based Surprise Adequacy (DSA) score, a confidence score, a logit score, or a robustness diversity score, for the second datapoint. The determination of the second set of feature scores may be similar to the determination of the first set of feature scores, as described further, for example, in FIG. 3 (at 306).

At block 408, a pre-trained classifier (e.g., the classifier 106) may be applied on the received second datapoint, based on the determined second set of feature scores, and the predicted second class for the second datapoint. The classifier 106 (or a meta-classifier) may be pre-trained to classify a datapoint into one of the set of semantic classes. Herein, each of the set of semantic classes may be indicative of a prediction accuracy associated with a set of datapoints clustered in corresponding semantic class of the set of semantic classes. The prediction accuracy associated with the set of semantic classes is described further, for example, in FIGS. 6A, 6B, and 7. In one or more embodiments, the processor 204 may be configured to apply the classifier 106 (i.e. trained at 312 in FIG. 3 and at FIGS. 6A, 6B, and 7) on the received second datapoint, based on the determined second set of feature scores, and the predicted second class for the second datapoint For example, a pre-trained K-NN classifier may be applied on the second datapoint based on the determined second set of feature scores and the predicted second class for the second datapoint. In an example, the K-NN classifier may be an N=5 nearest neighbor classifier.

At block 410, the second datapoint may be classified into one of the set of semantic classes based on the application of the pre-trained classifier (e.g., the classifier 106) on the second datapoint. In one or more embodiments, the processor 204 may be configured to classify the second datapoint into one of the set of sematic classes based on the application of the pre-trained classifier 106 on the second datapoint. Examples of the set of semantic classes may include, but are not limited to, a likely-correct semantic class, a one-of-two semantic class, a likely incorrect semantic class, or a do-not-know semantic class. The pre-trained classifier 106 may also output a confusing class pair associated with the second class in case the second datapoint is classified into the one-of-two semantic class. Each of the set of semantic classes may be easily understandable or interpretable by the end user (such as the user 114), in comparison to the confidence score or the prediction score provided by the DNN 104. The set of semantic classes may allow the end-user to make a more informed decision on how to use, or not use, the output of the DNN 104 in further actions.

At block 412, at least one action associated with the classified one of the set of semantic classes for the second datapoint may be determined. In one or more embodiments, the processor 204 may be configured to determine at least one action associated with the classified one of the set of semantic classes for the second datapoint. For example, in case the second datapoint is classified into the likely-correct semantic class, the processor 204 may determine the action as to reliably use (or accept) the class label (i.e. output by the DNN 104 for the second datapoint) as-is with a high confidence, by the user 114 or by the user-end device 110. In another example, in case the second datapoint is classified into a likely incorrect semantic class, the processor 204 may determine the action as a rejection of the class label output by the DNN 104 for the second datapoint and may further suggest using a human judgement by the user 114 to take decision for the prediction of the second datapoint. Further, in case the semantic class for the second datapoint is determined as the one-of-two semantic class, the processor 204 may determine the action as a use of a tie-breaker solution by the user 114. The tie-breaker solution may be a manual or an automated solution. For example, the automated solution may include training and use of a local classifier to specifically predict an accurate class for the second datapoint based on the confusing class pair associated with the second class predicted by the DNN 104. The local classifier may be only trained to accurate predict the classes which may be included in the confusing class pair. For example, in case the DNN 104 is trained to predict numerals (“0” to “9”) based on an input image (i.e. second datapoint) including handwritten number(s). In such case, the class labels for numerals “1” and “7” may be considered as the confusing class pair and clustered in the one-of-two semantic class by the DNN 104 and/or by the classifier 106. Thus, the tie-breaker solution may suggest an action to use the separate or the local classifier which is only trained to accurately classify “1” and “7” numeral images for better prediction and decision making by the user-end device 110 or the user 114. Further, in case the semantic class for the second datapoint is determined as the do-not-know semantic class, the processor 204 may determine the action as a use of a majority-vote solution by the user 114. The majority-vote solution may be a manual or an automated solution. For example, the automated solution may include training and using multiple DNNs for the classification task of the real-time application. The second datapoint may be fed to each DNN and prediction results of the DNNs may be compared. A class label predicted by a majority of the DNNs may be selected as a class label for the second datapoint as per the majority-vote solution.

At block 414, the determined at least one action may be rendered. In one or more embodiments, the processor 204 may be configured to render the determined at least one action. In an example, the processor 204 may render the determined action, predicted second class, and/or determined semantic class associated with the second datapoint as output information. In an embodiment, the output information may correspond to at least one of, but not limited to, a display of the determined action, predicted second class, and/or determined semantic class on the display screen 210A, a storage of the determined action, predicted second class, and/or determined semantic class in a log file, or a notification/alert based on the determined action, predicted second class, and/or determined semantic class. For example, the user-end device 110 (or the electronic device 102) may display the determined action, predicted second class, and/or determined semantic class associated with the second datapoint. In another example, the user-end device 110 (or the electronic device 102) may store the determined action, predicted second class, and/or determined semantic class associated with the second datapoint in a log file in a memory (such as the memory 206). For example, the log file may indicate how many times the DNN 104 has correctly predicted (or not) to determine the accuracy of the DNN 104 in a real-time operation (for example in an autonomous vehicle). In certain scenario, the determined action, and/or determined semantic class may be stored in the log file along with the predicted second class based on the determined semantic class. For example, the determined action, predicted second class, and/or determined semantic class may be stored in the log file when the semantic class is other than the likely-correct semantic class. In another example, the output information may be indicated as a notification (for example an alert or warning) to a user of the user-end device 110 (or the electronic device 102) based on the determined action, predicted second class, and/or determined semantic class. For example, in case, the user-end device 110 is an autonomous vehicle and the semantic class is one of the one-of-two semantic class, the likely-incorrect semantic class, or the do-not-know class, the user-end device 110 (i.e., the autonomous vehicle) may notify a user (for example a passenger of the autonomous vehicle). The notification may include a warning or alert for the user to take control of the autonomous vehicle due to a potential wrong prediction of the second class (e.g., a wrong classification or mis-identification of an object that may be an obstacle) performed by the DNN 104 being deployed in the user-end device 110. In some embodiments, the output information generated by the electronic device 102 may correspond to certain automatic actions to be taken, for example, in case of incorrect prediction of the DNN 104 detected by the classifier 106 as a semantic class (for the second datapoint) which may be other than the likely-correct semantic class. For example, in case of detection of mis-classification or incorrect prediction performed by the DNN 104 for the received second datapoint in the autonomous vehicle, the user-end device 110 or the electronic device 102 may generate the output information to automatically apply brakes, control steering, or significantly reduce speed of the autonomous vehicle. Control may pass to end.

Although the flowchart 400 is illustrated as discrete operations, such as 402, 404, 406, 408, 410, 412, and 414. However, in certain embodiments, such discrete operations may be further divided into additional operations, combined into fewer operations, or eliminated, depending on the particular implementation without detracting from the essence of the disclosed embodiments.

FIG. 5 is a flowchart of an example method for identification of a set of confusing classes associated with a Deep Neural Network (DNN), according to at least one embodiment described in the present disclosure. FIG. 5 is explained in conjunction with elements from FIG. 1, FIG. 2, FIG. 3, and FIG. 4. With reference to FIG. 5, there is shown a flowchart 500. The method illustrated in the flowchart 500 may start at 502 and may be performed by any suitable system, apparatus, or device, such as by the electronic device 102 of FIG. 1 or the example system 202 of FIG. 2. Although illustrated with discrete blocks, the steps and operations associated with one or more of the blocks of the method 500 may be divided into additional blocks, combined into fewer blocks, or eliminated, depending on the particular implementation.

At block 502, the predetermined class associated with the first datapoint may be compared with the predicted first class associated with the first datapoint. In one or more embodiments, the processor 204 may be configured to compare the predetermined class associated with the first datapoint with the predicted first class associated with the first datapoint. The prediction of the first class is described, for example, at 304 in FIG. 3. For example, the processor 204 may compare a class label (e.g., a dog class label) of the predetermined or predefined class of the first datapoint with a class label of the predicted first class (e.g., a cat class label), and further determine that the predetermined class is different from the predicted first class, based on the comparison. In other words, the processor 204 may compare an expected or ground truth class (i.e. predetermined class) with an actual class of the first datapoint predicted by the DNN 104.

At block 504, based on the comparison, a first instance of misclassification associated with a first class pair may be identified. The first class pair may include the predicted first class associated with the first datapoint and the predetermined class associated with the first datapoint. In one or more embodiments, the processor 204 may be configured to identify the first instance of misclassification associated with the first class pair including the predicted first class and the predetermined class. For example, if the predicted first class associated with the first datapoint is a cat class and the predetermined class associated with the first datapoint is a dog class, the processor 204 may determine that the first datapoint is misclassified. In such case, the first instance of misclassification associated with the first class pair for the first datapoint may be identified. Herein, the first class pair may include the cat class (i.e., the predicted first class) and the dog class (i.e., the predetermined class) for the first datapoint.

At block 506, a count of instances of misclassifications associated with the first class pair may be determined based on the identified first instance of misclassification. In one or more embodiments, the processor 204 may be configured to determine the count of instances of misclassifications associated with the first class pair, based on the identified first instance of misclassification. Similar to the prediction of the first class associated with the first datapoint by the DNN 104, the processor 204 may control the DNN 104 to predict the first class associated with each datapoint in the received first dataset (as described at 304 in FIG. 3). Similar to the comparison described at 502, the processor 204 may compare the predicted first class associated with each datapoint in the received first dataset with a predetermined class associated with corresponding datapoint in the received first dataset. Further, similar to the identification of the first instance of misclassification associated with the first class pair (as described at 504) for the first datapoint, the processor 204 may identify other instances of misclassifications associated with the first class pair (e.g., the dog class and the cat class) or other class pair for all datapoints in the first dataset. The processor 204 may increase the count of instances of misclassification for different class pairs, whenever the corresponding class pair is identified based on the misclassification of a particular datapoint in the first dataset. The processor 204 may further determine the count of instances of misclassifications associated with the first class pair (e.g., the dog class and the cat class) or other class pairs (for example including other predetermined or predicted classes on which the DNN 104 may be trained) based on the identification of the first instance of misclassification for the first datapoint and the other instances of misclassifications for the datapoints in the first dataset other than the first datapoint. In an embodiment, the processor 204 may include all different class pairs (i.e. including different pairs of predetermined class and predicted class) identified for different misclassified or incorrectly predicted datapoints in the first dataset in a set of confusing class pairs.

At block 508, the first class pair may be identified as a confusing class pair in the set of confusing class pairs, based on the count of instances of the misclassifications for the first class pair and a threshold. In one or more embodiments, the processor 204 may be configured to identify the first class pair (e.g., the dog class and the cat class) as a confusing class pair in the set of confusing class pairs, based on the count of instances of the misclassifications for the first class pair and the threshold. For example, in case the threshold is 100 and the count of instances of the misclassifications associated with the first class pair (e.g., the dog class and the cat class) for different datapoints is 120, the first class pair may be identified as a confusing class pair in the set of confusing class pairs, as the count of instances of misclassifications for the first class pair is more than the threshold. In certain embodiments, the processor 204 may be configured to sort a set of class pairs (including the first class pair) based on the count of instances of misclassifications of each class pair in a descending order. Further, the processor 204 may be configured to select or identify first N class pairs (i.e. Top N class pairs) in the sorted order as the set of confusing class pairs, rather than selecting all different class pairs in the set of confusing class pairs . In addition, the processor 204 may also select one or more class pairs from the set of class pairs as the confusing class pairs based on the threshold. For example, all the class pairs with corresponding count of instances of misclassifications higher than the predefined threshold may be considered as most confusing class pairs (i.e. identified set of confusing class pairs) for the first dataset predicted by the DNN 104. For example, based on the prediction of each datapoint of the first dataset, the class pair including dog class and the cat class may have highest misclassification than other class pairs identified in the prediction of the first dataset. In another example, the class pair including numeral “1” class label and numeral “7” class label may be most misclassified for a dataset, as both numeral “1” and “7” may have similar features for the handwritten datapoints. Control may pass to end.

Although the flowchart 500 is illustrated as discrete operations, such as 502, 504, 506, and 508. However, in certain embodiments, such discrete operations may be further divided into additional operations, combined into fewer operations, or eliminated, depending on the particular implementation without detracting from the essence of the disclosed embodiments.

FIGS. 6A and 6B collectively illustrate a flowchart of an example method for clustering of a received first dataset into one of a set of semantic classes for training of a classifier, according to at least one embodiment described in the present disclosure. FIGS. 6A and 6B are explained in conjunction with elements from FIG. 1, FIG. 2, FIG. 3, FIG. 4, and FIG. 5. With reference to FIGS. 6A and 6B, there is shown a flowchart 600. The method illustrated in the flowchart 600 may start at 602 and may be performed by any suitable system, apparatus, or device, such as by the electronic device 102 of FIG. 1 or the example system 202 of FIG. 2. Although illustrated with discrete blocks, the steps and operations associated with one or more of the blocks of the method 600 may be divided into additional blocks, combined into fewer blocks, or eliminated, depending on the particular implementation.

FIG. 7 illustrates an exemplary scenario of a program code of an algorithm for clustering of a received first dataset into one of a set of semantic classes, arranged in accordance with at least one embodiment described in the present disclosure. With reference to FIG. 7, there is shown an example scenario 700. The example scenario 700 may include a program code including a function 702 to cluster the received first dataset into one of a set of semantic classes. In an embodiment, the program code including the function 702 may be stored in either or combination of the memory 206, the persistent data storage 208, or the database 108. The function 702 may include an initialization statement 704, a clustering code 706, a conditional code 708, a first recursive call 710 included in the conditional code 708, a second recursive call 712, and a return statement 714. The processor 204 may be configured to execute the function 702 to iteratively cluster the received first dataset into one of the set of semantic classes. The flowchart 600 is now described in conjunction with the example scenario 700 of the function 702.

With reference to FIG. 6A, at block 602, the received first dataset may be selected as a current sample to be clustered. In one or more embodiments, the processor 204 may be configured to select the received first dataset as the current sample to be clustered. With reference to FIG. 7, the function 702 (i.e., a function “train(T)”) may include the initialization statement 704 as a first statement. The processor 204 may execute the initialization statement 704 to assign values to a group of variable sets. For example, the group of variable sets may include an “R” set (representative of a reliable semantic class, such as, the likely-correct semantic class), a “U” set (representative of an unreliable semantic class, such as, the likely-incorrect semantic class), and a “C” set (representative of a confusing class, such as, the one-of-two semantic class). The group of variable sets may further include an “N” set that may be representative of a no group semantic class, such as, the do-not-know class. As shown in FIG. 7, the sets “R”, “U”, and “C” may be initialized as empty sets and the set “N” may be initialized with training data “T”. With reference to FIGS. 6A and 7, the first dataset may be selected as the current sample (i.e., the training data “T”) in the first iteration of the recursive function 702. Herein, initially the entire first dataset may be assigned to the set “N” (i.e. do-not-know class), as the semantic class of the entire first dataset may not be known. A set of operations from 604 to 620 may be controlled for the clustering of the received first dataset, as described next.

With reference to FIG. 6A, at block 604, the selected current sample may be clustered into one of a first accuracy group or a second accuracy group, based on a third set of feature scores of each datapoint in the selected current sample. In one or more embodiments, the processor 204 may be configured to cluster the selected current sample into one of the first accuracy group or the second accuracy group, based on the third set of feature scores of each datapoint in the selected current sample. To cluster the selected current sample, the processor 204 may determine the third set of feature scores for each datapoint in the selected current sample. The third set of features scores for a datapoint may include, but are not limited to, the LSA score, the DSA score, the confidence score, the logit score, and the robustness diversity score, for each datapoint. The determination of the third set of feature scores may be similar to the determination of the first set of feature scores, as described further, for example, in FIG. 3 (at 306). The selected current sample may be clustered into one of the first accuracy group based on at least one of, but not limited to, a k-means clustering algorithm, or any unsupervised clustering algorithm.

In an embodiment, the first accuracy group may have a higher prediction accuracy than the second accuracy group.

For example, with reference to FIG. 7, the processor 204 may be configured to execute the clustering code 706 to cluster the selected current sample (i.e., the set “N” that is initialized as the first dataset) into one of the first accuracy group or the second accuracy group. A set “H” may be representative of the first accuracy group and a set “L” may be representative of the second accuracy group. Based on the clustering (e.g., k-means clustering), the set “H” may be assigned datapoints associated with the first accuracy group and the set “L” may be assigned datapoints associated with the second accuracy group. In an example, herein a minimum cluster size (i.e., a minimum group size threshold, which may be denoted by n) may be 2 (i.e., n=2). As shown in FIG. 7, the sets “H” and “L” may be sorted by correctness. The correctness associated with datapoints clustered in each of the first accuracy group (i.e., in the set “H”) and the second accuracy group (i.e., in the set “L”) may be determined based on a class predicted by the DNN 104 for corresponding datapoint and a predetermined class associated with the corresponding datapoint.

With reference to FIG. 6A, at block 606, an accuracy score associated with the first accuracy group may be determined based on a class predicted by the DNN 104 for each of a first set of datapoints in the first accuracy group and based on a predetermined class associated with corresponding datapoint in the first set of datapoints. In one or more embodiments, the processor 204 may be configured to determine the accuracy score associated with the first accuracy group. The accuracy score associated with the first accuracy group may be determined based on the class predicted by the DNN 104 for each of the first set of datapoints in the first accuracy group and based on the predetermined class associated with corresponding datapoint in the first set of datapoints. For each datapoint in the first set of datapoints, the processor 204 may control the DNN 104 to predict the class associated with the corresponding datapoint. The processor 204 may then compare the predicted class for each datapoint with the predetermined class associated with the corresponding datapoint to determine whether the prediction for the datapoint is accurate or not. The accuracy score of the first accuracy group may be determined as a ratio of a number of datapoints in the first accuracy group (i.e., the set “H”) that are correctly classified to the total number of datapoints in the first accuracy group.

At block 608, a second set of datapoints in the second accuracy group may be stored in a Last-In-First-Out (LIFO) data structure, based on a number of second set of datapoints and the minimum group size threshold (i.e., n). In one or more embodiments, the processor 204 may be configured to store the second set of datapoints in the second accuracy group in the LIFO data structure, based on the number of the second set of datapoints and the minimum group size threshold (i.e., n). The processor 204 may compare the number of the second set of datapoints with the minimum group size threshold (i.e., n). If the number of the second set of datapoints is determined as more than the minimum group size threshold (for example, n=2), the processor 204 may store the second set of datapoints in the LIFO data structure. In an example, the LIFO data structure may be a stack data structure, which may be denoted by S. For example, the processor 204 may push the second set of datapoints of the second accuracy group in the stack data structure. The LIFO structure may be stored in one or more of, but not limited to, the memory 206, the persistent data storage 208, or the database 108.

For example, with reference to FIG. 7, the second recursive call 712 in the function 702 may be used to recursively call the function 702 with the second set of datapoints in the second accuracy group as a function argument. For example, program code “train (L)” of the second recursive call 712 may recursively call the train( ) function (i.e., the function 702) with the set “L” as a function argument. As discussed in the aforementioned, the set “L” may include the second set of datapoints in the second accuracy group.

With reference to FIG. 6A, at block 610, the determined accuracy score associated with the first accuracy group may be compared with an accuracy threshold associated with each of the set of semantic classes. In one or more embodiments, the processor 204 may be configured to compare the determined accuracy score associated with the first accuracy group with the accuracy threshold associated with each of the set of semantic classes. For example, with reference to FIG. 7, the processor 204 may be configured to execute the conditional code 708 to compare determined accuracy score associated with the first accuracy group with the accuracy threshold associated with each of the semantic classes. For example, program code “if (accuracy(H, R)>r_a)” in the conditional code 708 may be used to compare the accuracy score associated with the first accuracy group (including datapoints in the set “H”) with an accuracy threshold (e.g., “r_a”) associated with the likely-correct semantic class (including datapoints in the set “R”). In an example, the accuracy threshold associated with the likely-correct semantic class may be 97% or 0.97. Further, program code “if (accuracy(H, C)>c_a+/−r)” in the conditional code 708 may be used to compare the accuracy score associated with the first accuracy group with a range of accuracy value threshold (e.g., “c_a+/−r”) associated with the one-of-two semantic class (including datapoints in the set “C”). In other words, the accuracy score associated with the first accuracy group may be compared with a range of accuracy value threshold determined based on the accuracy threshold (i.e., “c_a”) and a range threshold (e.g., “r”). In an example, the range of accuracy value threshold associated with the one-of-two semantic class may be 50%+/−5%, (i.e., 45% to 55%, or 0.45 to 0.55). Further, program code “if (accuracy(H, U)>u_a)” in the conditional code 708 may be used to compare the accuracy score associated with the first accuracy group with an accuracy threshold (e.g., “u_a”) associated with the likely-incorrect semantic class (including datapoints in the set “U”). In an example, the accuracy threshold associated with the likely-incorrect semantic class may be 35% or 0.35. In an embodiment, the accuracy threshold (e.g., “r_a”) associated with the likely-correct semantic class, the range of accuracy value threshold (e.g., “c_a+/−r”) associated with the one-of-two semantic class, and the accuracy threshold (e.g., “u_a”) associated with the likely-incorrect semantic class may be the indicative of prediction accuracy associated with the set of datapoints clustered in corresponding semantic class (i.e. mentioned at 310 in FIG. 3).

With reference to FIG. 6A, at block 612, the first set of datapoints in the first accuracy group may be assigned to one of the set of semantic classes based on the comparison. In one or more embodiments, based on the comparison at 610, the processor 204 may be configured to assign the first set of datapoints in the first accuracy group to one of the set of semantic classes. For example, with reference to FIG. 7, in case the accuracy score associated with the first accuracy group is determined as greater than the accuracy threshold (i.e., “r_a”) associated with the likely-correct semantic class, the processor 204 may assign the first set of datapoints in the first accuracy group to the set “R”. For example, the program code “R=merge (H, R)” may be used to merge the first set of datapoints with datapoints already present in the set “R” and thereby assign the first set of datapoints to the set “R”. As discussed in the aforementioned, the set “R” may include datapoints that may be associated with the likely-correct semantic class. Otherwise, in case the accuracy score associated with the first accuracy group is determined to lie within the range of accuracy value threshold (i.e., “c_a+/−r”) associated with the one-of-two semantic class, the processor 204 may assign the first set of datapoints in the first accuracy group to the set “C”. For example, the program code “C=merge (H, C)” may be used to merge the first set of datapoints with datapoints already present in the set “C” and thereby assign the first set of datapoints to the set “C”. As discussed in the aforementioned, the set “C” may include datapoints that may be associated with the one-of-two semantic class. In another scenario where the accuracy score associated with the first accuracy group is determined as less than the accuracy threshold (i.e., “u_a”) associated with the likely-incorrect semantic class, the processor 204 may assign the first set of datapoints in the first accuracy group to the set “U”. For example, the program code “U=merge (H, U)” may be used to merge the first set of datapoints with datapoints already present in the set “U” and thereby assign the first set of datapoints to the set “U”. As discussed in the aforementioned, the set “U” may include datapoints that may be associated with the likely-incorrect semantic class.

With reference to FIG. 6A, at block 614, the first set of datapoints in the first accuracy group may be stored in the LIFO data structure, based on the comparison, a number of the first set of datapoints and the minimum group size threshold (i.e., n). In one or more embodiments, the processor 204 may be configured to store the first set of datapoints in the first accuracy group in the LIFO data structure, based on the comparison (at 610), the number of the first set of datapoints and the minimum group size threshold (i.e., n). Based on the comparison at 610, if the first set of datapoints do not qualify to be clustered in one of the likely-correct, one-of-two, or likely-incorrect semantic classes, the first set of datapoints may be eligible for storage in the LIFO data structure. In case the first set of datapoints is eligible for storage in the LIFO data structure, the first set of datapoints may be stored in the LIFO data structure based on a comparison of the number of the first set of datapoints with the minimum group size threshold (i.e., n). For example, if the number of the first set of datapoints is determined as more than the minimum group size threshold (for example, n=2), the processor 204 may store the first set of datapoints in the LIFO data structure. For example, the processor 204 may push the first set of datapoints in the first accuracy group in the stack data structure “S”. The LIFO structure may be stored in one or more of, but not limited to, the memory 206, the persistent data storage 208, or the database 108.

For example, with reference to FIG. 7, the first recursive call 710 in the function 702 may be used to recursively call the function 702 with the first set of datapoints in the first accuracy group as a function argument. For example, program code “|H|>n : train (H)” of the first recursive call 710 may recursively call the train( ) function (i.e., the function 702) with the set “H” as a function argument, in case the number of the first set of datapoints is greater than the minimum group size threshold (i.e., n). As discussed in the aforementioned, the set “H” may include the first set of datapoints in the first accuracy group.

With reference to FIG. 6B, at block 616, it may be determined whether the LIFO data structure is empty. In one or more embodiments, the processor 204 may be configured to determine whether the LIFO data structure is empty. The check to determine whether the LIFO data structure is empty, may be executed to control the recursive iterations of the function 702 of FIG. 7.

At block 618, a third set of datapoints may be retrieved from the LIFO data structure based on the determination that the LIFO data structure is not empty. In one or more embodiments, based on the determination that the LIFO data structure is not empty (as determined based on the check at 616), the processor 204 may be configured to retrieve the third set of datapoints from the LIFO data structure. Based on the last-in-first-out property of the LIFO data structure (e.g., the stack “S”), a set of datapoints that are most recently pushed into the LIFO data structure may be popped and retrieved as the third set of datapoints from the LIFO data structure (i.e., the stack “S”). In an embodiment, the first set of datapoints of the first accuracy group (i.e. stored in LIFO data structure at 614) may be retrieved as the third set of datapoints. In another embodiment, the second set of datapoints of the second accuracy group (i.e. stored in LIFO data structure at 608) may be retrieved as the third set of datapoints.

At block 620, the retrieved third set of datapoints may be re-selected as the current sample to be clustered. In one or more embodiments, the processor 204 may be configured to re-select the retrieved third set of datapoints as the current sample. The re-selection of the retrieved third set of datapoints as the current sample to be further clustered may be similar to the selection of the received first dataset as the current sample to be clustered, as described at 602. For example, with reference to FIG. 7, the processor 204 may be configured to execute the initialization statement 704, for a next recursive iteration of the function 702. Herein, the training data “T” may be assigned with the retrieved third set of datapoints based on the re-selection of the retrieved third set of datapoints as the current sample from the LIFO data structure. In other words, the training data “T”, which is the argument of the function 702, may be assigned as the current sample. Further, the control may pass to 604, as shown in FIG. 6B. Therefore, for the current sample newly selected, the processor 204 may again perform 604-614 to cluster the datapoints in the current sample into one of the set of semantic classes.

With reference to FIG. 6B, at block 622, the clustered first dataset may be obtained based on the determination that the LIFO data structure is empty. In one or more embodiments, the processor 204 may be configured to obtain the clustered first dataset based on iterative control of the set of operations from 604 to 620 based on the determination that the LIFO data structure is empty. The determination that the LIFO data structure is empty may indicate that all recursive iterations of the function 702 of FIG. 7 have been processed and the first dataset has been clustered for most or all the datapoints in the first dataset. For example, with reference to FIG. 7, at the final recursive iteration of the function 702, the processor 204 may execute the return statement 714 to return the sets “R”, “U”, “C”, and “N” with the clustered first dataset. Thus, the first dataset may be clustered in the set of semantic classes including the likely-correct semantic class (i.e., the set “R”), the likely-incorrect semantic class (i.e., the set “U”), the one-of-two semantic class (i.e., the set “C”), and the do-not-know semantic class (i.e., the set “N”).

With reference to FIG. 6B, at block 624, the clustered first dataset may be re-clustered based on the identified set of confusing class pairs and the predicted first class for each datapoint in the received first dataset. In one or more embodiments, the processor 204 may be configured to re-cluster the clustered first dataset based on the identified set of confusing class pairs and the predicted first class for each datapoint in the received first dataset. For each datapoint in the received first dataset, the processor 204 may determine whether the datapoint is clustered in the one-of-two semantic class (i.e. described, for example, in FIG. 5). In other words, the processor 204 may determine whether the predicted first class for the datapoint is included in the set of confusing class pairs. In case the datapoint is clustered in the one-of-two semantic class (i.e., the confusing class set “C”), however, the predicted first class for the datapoint is not included in the set of confusing class pairs, the processor 204 may re-cluster the datapoint into the do-not-know semantic class. Otherwise, if the datapoint is clustered in a semantic class other than the one-of-two semantic class, or if the datapoint is clustered in the one-of-two semantic class and the predicted first class is included in the set of confusing class pairs, the datapoint may not be re-clustered. For example, in case of a number recognition application, numbers “1” and “7” may be a confusing class pair in the set of confusing class pairs. If a datapoint is clustered in the one-of-two semantic class and the predicted first class of the datapoint is a number “3”, the processor 204 may re-cluster the datapoint into the do-not-know semantic class, as the predicted first class of the datapoint may not belong to a confusing class pair. However, if the predicted first class of datapoint is “1” (which may belong to a confusing class pair) and the datapoint is clustered in the one-of-two semantic class, the datapoint may not be re-clustered.

At block 626, the classifier 106 may be trained based on the re-clustered first dataset, the determined third set of feature scores, and the set of semantic classes. In one or more embodiments, the processor 204 may be configured to control a training of a classifier (e.g., the classifier 106) based on the re-clustered first dataset, the determined third set of feature scores, and the set of semantic classes. Examples of the classifier 106 may include, but are not limited to, a decision tree classifier, a Support Vector Machine (SVM) classifier, a Naïve Bayes classifier, a Logistic Regression classifier, or a k-nearest neighbor (K-NN) classifier. In an example, the classifier 106 may be built and trained as a K-NN classifier with K=5 nearest neighbors. As an example, a Scikit-Learn library may be used to build and train the K-NN classifier. For example, the classifier 106 may be trained on a relationship between the third set of feature scores (i.e. similar to the first set of feature scores and/or the second set of feature scores) and clustered set of semantic classes for each datapoint in the first dataset as described, for example, at 312 in FIG. 3. Based on the training of the K-NN classifier (e.g., the classifier 106), the K-NN classifier may output one of the set of semantic classes as described, for example, in FIG. 4. Based on the relationship learned by the classifier 106, the classifier 106 may classify a new datapoint (i.e. second datapoint) into one of the set of semantic classes based on the second set of feature scores determined for the new datapoint as described, for example, in FIG. 4 (at 406-410). Control may pass to end.

Although the flowchart 600 is illustrated as discrete operations, such as 602, 604, 606, 608, 610, 612, 614, 616, 618, 620, 622, 624, and 626. However, in certain embodiments, such discrete operations may be further divided into additional operations, combined into fewer operations, or eliminated, depending on the particular implementation without detracting from the essence of the disclosed embodiments. It may be noted that the scenario 700 (including the program code) shown in FIG. 7 is presented merely as example and should not be construed to limit the scope of the disclosure.

Therefore, the disclosed electronic device 102 may partition an input space of the DNN 104 into various semantic classes that may be human comprehensible and may help humans (i.e. user 114) to understand the prediction output of the DNN 104 in more meaning way. A semantic class may indicate the predictive accuracy (such as described, for example, at 610 in FIG. 6A) of datapoints clustered in the semantic class. The clustering of a datapoint in a certain semantic class may be used to provide a user with a qualitative feedback regarding a reliability of the DNN 104 in classifying the datapoint and may further enable the user to take an informed or actionable decision based on the qualitative feedback. This may further enhance the accuracy of the prediction or classification of the DNN 104, by appropriate detection of mis-classification or incorrect prediction, and taking certain actions (as the output information) to avoid any financial or physical loss due to mis-predictions. Based on the qualitative feedback and/or easy understanding of one of the clustered set of semantic classes provided by the disclosed electronic device 102 for a particular datapoint, the user 114 or the user-end device 110 may trust the DNN 104 and accordingly take appropriate or actionable decisions, such as (but not limited to) rely on the prediction of the datapoint as-is, simply discard the prediction of the datapoint, control the DNN 104 to perform the prediction again for the datapoint, pass the datapoint to another DNN model (i.e. tie-breaker solution described at 412 in FIG. 4) to get more reliable output, or to perform majority-vote solution among multiple DNN model (described at 412 in FIG. 4).

An exemplary dataset and experimental setup for the disclosure is presented in Table 1, as follows:

TABLE 1
Exemplary dataset and experimental setup of the disclosure

| Dataset and | |
|---|---|
| Experimental setup | Values |
| Dataset used | Canadian Institute For Advanced Research |
| | (CIFAR)-10 image dataset with 50000 training |
| | images and 10000 test images of 10 classes |
| | including aero plane, automobile, bird, cat, |
| | dog, deer, frog, horse, ship, and truck |
| DNN used | Visual Geometry Group (VGG)-16 convolutional |
| | neural network |
| Convolution layer used | A last convolution layer that precedes the output |
| for feature extraction | layer of the DNN used for extraction of the |
| | LSA score and the DSA score. |
| Number of variants for | 16 |
| robustness diversity | |
| score | |
| Thresholds for | Likely-correct semantic class: 97% |
| semantic classes | One-of-two semantic class: 50% +/− 5% |
| | Likely-incorrect semantic class: 40% |
| Number of neighbors | 5 |
| in K-NN classifier | |

It should be noted that data provided in Table 1 may merely be taken as experimental data and may not be construed as limiting the present disclosure.

Exemplary experimental datasets and results of training phase of a classifier (i.e. described in FIGS. 3, 6A, 6B and 7) for clustering of datapoints to the set of semantic classes are presented in Table 2, as follows:

TABLE 2
Exemplary experimental datasets and results of
training phase of a classifier for clustering
of datapoints to the set of semantic classes

| | | | | |
|---|---|---|---|---|
| Semantic | Correctly | Incorrectly | | |
| Class | predicted | predicted | Accuracy | Proportion |

Model-1 (Accuracy 87.7%)

| | | | | |
|---|---|---|---|---|
| Likely Correct | 3001 | 87 | 97% | 64% |
| One-of-Two | 72 | 82 | 52% | 3% |
| Likely | 25 | 31 | 35% | 1% |
| Incorrect | | | | |
| Do-not-know | 1133 | 388 | 71% | 32% |

Model-2 (Accuracy 74.8%)

| | | | | |
|---|---|---|---|---|
| Likely Correct | 1717 | 53 | 97% | 44% |
| One-of-Two | 354 | 392 | 47% | 19% |
| Likely | 89 | 257 | 26% | 9% |
| Incorrect | | | | |
| Do-not-know | 844 | 309 | 73% | 29% |

Model-3 (Accuracy 92.3%)

| | | | | |
|---|---|---|---|---|
| Likely Correct | 3385 | 104 | 97% | 86% |
| One-of-Two | 79 | 73 | 62% | 4% |
| Likely | 24 | 44 | 35% | 2% |
| Incorrect | | | | |
| Do-not-know | 217 | 87 | 71% | 8% |

It should be noted that data provided in Table 2 may merely be taken as experimental data and may not be construed as limiting the present disclosure.

Exemplary experimental datasets and results of operational (i.e., real-time) phase (i.e. described in FIG. 4) of the classifier for clustering of a new datapoint into one of the set of semantic classes are presented in Table 3, as follows:

TABLE 3
Exemplary experimental datasets and results of operational
(i.e., real-time) phase of the classifier for clustering
of a new datapoint into one of the set of semantic classes.

| | | | | |
|---|---|---|---|---|
| Semantic | Correctly | Incorrectly | | |
| Class | predicted | predicted | Accuracy | Proportion |

Model-1 (Accuracy 87.7%)

| | | | | |
|---|---|---|---|---|
| Likely Correct | 3111 | 96 | 97% | 64% |
| One-of-Two | 76 | 85 | 47% | 3% |
| Likely | 19 | 34 | 36% | 1% |
| Incorrect | | | | |
| Do-not-know | 1176 | 432 | 73% | 32% |

Model-2 (Accuracy 74.8%)

| | | | | |
|---|---|---|---|---|
| Likely Correct | 383 | 5 | 99% | 39% |
| One-of-Two | 94 | 110 | 46% | 21% |
| Likely | 55 | 88 | 38% | 16% |
| Incorrect | | | | |
| Do-not-know | 195 | 55 | 78% | 25% |

Model-3 (Accuracy 92.3%)

| | | | | |
|---|---|---|---|---|
| Likely Correct | 819 | 28 | 97% | 85% |
| One-of-Two | 45 | 23 | 66% | 7% |
| Likely | 36 | 11 | 77% | 5% |
| Incorrect | | | | |
| Do-not-know | 22 | 12 | 64% | 3% |

It should be noted that data provided in Table 3 may merely be taken as experimental data and may not be construed as limiting the present disclosure.

Various embodiments of the disclosure may provide one or more non-transitory computer-readable storage media configured to store instructions that, in response to being executed, cause a system (such as the example system 202 or the electronic device 102) to perform operations. The operations may include receiving a first dataset associated with a real-time application. The operations may further include predicting, by a Deep Neural Network (DNN) pre-trained for a classification task of the real-time application, a first class associated with a first datapoint of the received first dataset. The operations may further include determining a first set of feature scores for the first datapoint based on the predicted first class associated with the first datapoint. The operations may further include identifying a set of confusing class pairs associated with the DNN based on the predicted first class and a predetermined class associated with the first datapoint. The operations may further include clustering the received first dataset into one of a set of semantic classes based on the determined first set of features scores, the predicted first class, and the identified set of confusing class pairs for each datapoint in the received first dataset. Each of the set of semantic classes may be indicative of a prediction accuracy associated with a set of datapoints clustered in corresponding semantic class of the set of semantic classes. The operations may further include training a classifier based on the clustered first dataset, the determined first set of feature scores, and the set of semantic classes.

Various embodiments of the disclosure may provide one or more non-transitory computer-readable storage media configured to store instructions that, in response to being executed, cause a system (such as the example system 202 or the electronic device 102) to perform operations. The operations may include receiving a second datapoint associated with a real-time application. The operations may further include predicting, by a Deep Neural Network (DNN) pre-trained for a classification task of the real-time application, a second class associated with the second datapoint. The operations may further include determining a second set of feature scores for the second datapoint based on the predicted second class associated with the received second datapoint. The operations may further include applying a pre-trained classifier on the received second datapoint, based on the determined second set of feature scores and the predicted second class. The classifier may be pre-trained to classify a datapoint into one of a set of semantic classes. Each of the set of semantic classes may be indicative of a prediction accuracy associated with a set of datapoints clustered in corresponding semantic class of the set of semantic classes. The operations may further include classifying the second datapoint into one of the set of semantic classes based on the application of the pre-trained classifier on the second datapoint. The operations may further include determining at least one action associated with the classified one of the set of semantic classes for the second datapoint. The operations may further include rendering the determined at least one action.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated. In this description, a “computing entity” may be any computing system as previously defined in the present disclosure, or any module or combination of modulates running on a computing system.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A method, executed by a processor, comprising:
receiving a first dataset associated with a real-time application;
predicting, by a Deep Neural Network (DNN) pre-trained for a classification task of the real-time application, a first class associated with a first datapoint of the received first dataset;
determining a first set of feature scores for the first datapoint based on the predicted first class associated with the first datapoint;
identifying a set of confusing class pairs associated with the DNN based on the predicted first class and a predetermined class associated with the first datapoint;
clustering the received first dataset into one of a set of semantic classes based on the determined first set of features scores, the predicted first class, and the identified set of confusing class pairs for each datapoint in the received first dataset, wherein
each of the set of semantic classes is indicative of a prediction accuracy associated with a set of datapoints clustered in corresponding semantic class of the set of semantic classes; and
training a classifier based on the clustered first dataset, the determined first set of feature scores, and the set of semantic classes.

2. The method according to claim 1, further comprising:
receiving a second datapoint associated with the real-time application;
predicting, by the DNN, a second class associated with the received second datapoint;
determining a second set of feature scores for the second datapoint based on the predicted second class associated with the received second datapoint;
applying the trained classifier on the second datapoint based on the determined second set of feature scores and the predicted second class; and
classifying the second datapoint into one of the set of semantic classes based on the application of the trained classifier on the second datapoint.

3. The method according to claim 2, further comprising:
determining at least one action associated with the classified one of the set of semantic classes for the second datapoint; and
rendering the determined at least one action.

4. The method according to claim 1, wherein the set of semantic classes comprises at least one of a likely-correct semantic class, a one-of-two semantic class, a likely incorrect semantic class, or a do-not-know semantic class.

5. The method according to claim 1, wherein the first set of feature scores comprises at least one of a Likelihood-based Surprise Adequacy (LSA) score, a Distance-based Surprise Adequacy (DSA) score, a confidence score, a logit score, or a robustness diversity score, for the first datapoint.

6. The method according to claim 5, wherein the LSA score is indicative of whether the first datapoint is in-distribution with the first dataset.

7. The method according to claim 5, wherein the DSA score is indicative of whether the first datapoint is closer to the predicted first class than another class neighboring to the predicted first class in a hyper-space associated with the DNN.

8. The method according to claim 5, wherein the confidence score corresponds to a probability score of the DNN for the prediction of the first class associated with the first datapoint.

9. The method according to claim 5, wherein the logit score corresponds to a score from a pre-softmax layer of the DNN for the prediction of the first class associated with the first datapoint.

10. The method according to claim 5, wherein the robustness diversity score is indicative of a degree of stability of a prediction by the DNN for one or more variations corresponding to the first datapoint.

11. The method according to claim 1, wherein the identification of the set of confusing class pairs further comprises:
comparing the predetermined class associated with the first datapoint with the predicted first class associated with the first datapoint;
based on the comparison, identifying a first instance of misclassification associated with a first class pair including the predicted first class and the predetermined class;
determining a count of instances of misclassifications associated with the first class pair, based on the identified first instance of misclassification; and
identifying the first class pair as a confusing class pair in the set of confusing class pairs, based on the count of instances of the misclassifications and a threshold.

12. The method according to claim 1, further comprising:
selecting the received first dataset as a current sample to be clustered;
controlling a set of operations for the clustering of the received first dataset, wherein the set of operations comprise:
clustering the selected current sample into one of a first accuracy group or a second accuracy group, based on a third set of feature scores of each datapoint in the selected current sample,
determining an accuracy score associated with the first accuracy group based on a class predicted by the DNN for each of a first set of datapoints in the first accuracy group and based on a predetermined class associated with corresponding datapoint in the first set of datapoints,
storing a second set of datapoints in the second accuracy group in a Last-in-First-out (LIFO) data structure based on a number of the second set of datapoints and a minimum group size threshold,
comparing the determined accuracy score associated with the first accuracy group with an accuracy threshold associated with each of the set of semantic classes,
assigning the first set of datapoints in the first accuracy group to one of the set of semantic classes based on the comparison,
determining whether the LIFO data structure is empty,
retrieving a third set of datapoints from the LIFO data structure based on the determination that the LIFO data structure is not empty, and
re-selecting the retrieved third set of datapoints as the current sample to be clustered; and
obtaining the clustered first dataset based on iterative control of the set of operations based on the determination that the LIFO data structure is empty.

13. The method according to claim 12, wherein the set of operations further comprise storing the first set of datapoints of the first accuracy group in the LIFO data structure based on the comparison, a number of the first set of datapoints, and the minimum group size threshold.

14. The method according to claim 1, further comprising:
re-clustering the clustered first dataset into the set of semantic classes, based on the identified set of confusing class pairs and the predicted first class for each datapoint in the received first dataset; and
training the classifier based on the re-clustered first dataset, the determined first set of feature scores, and the set of semantic classes.

15. The method according to claim 12, wherein the selected current sample is clustered based on a k-means clustering algorithm.

16. The method according to claim 1, wherein the classifier corresponds to a K-Nearest Neighbor (K-NN) classifier.

17. The method according to claim 1, wherein the first datapoint corresponds to one of image data, audio data, or text data, and wherein the real-time application comprises one of an image classification, a speech recognition, or text recognition.

18. A method, executed by a processor, comprising:
receiving a datapoint associated with a real-time application;
predicting, by a Deep Neural Network (DNN) pre-trained for a classification task of the real-time application, a class associated with the datapoint;
determining a set of feature scores for the received datapoint based on the predicted class associated with the received datapoint;
applying a pre-trained classifier on the received datapoint, based on the determined set of feature scores and the predicted class, wherein
the classifier is pre-trained to classify a datapoint into one of a set of semantic classes, and
each of the set of semantic classes is indicative of a prediction accuracy associated with a set of datapoints clustered in corresponding semantic class of the set of semantic classes;
classifying the received datapoint into one of the set of semantic classes based on the application of the pre-trained classifier on the received datapoint;
determining at least one action associated with the classified one of the set of semantic classes for the received datapoint; and
rendering the determined at least one action.

19. The method according to claim 18, wherein the set of semantic classes comprises at least one of a likely-correct semantic class, a one-of-two semantic class, a likely incorrect semantic class, or a do-not-know semantic class.

20. An electronic device, comprising:
a memory storing instructions;
a Deep Neural Network (DNN) pre-trained for a classification task of a real-time application; and
a processor, coupled to the memory and the DNN, that executes the instructions to perform a process comprising:
receiving a first dataset associated with the real-time application;
predicting, by the Deep Neural Network (DNN), a first class associated with a first datapoint of the received first dataset;
determining a first set of feature scores for the first datapoint based on the predicted first class associated with the first datapoint;
identifying a set of confusing class pairs associated with the DNN based on the predicted first class and a predetermined class associated with the first datapoint;
clustering the received first dataset into one of a set of semantic classes based on the determined first set of features scores, the predicted first class, and the identified set of confusing class pairs for each datapoint in the received first dataset, wherein
each of the set of semantic classes is indicative of a prediction accuracy associated with a set of datapoints clustered in corresponding semantic class of the set of semantic classes; and
training a classifier based on the clustered first dataset, the determined first set of feature scores, and the set of semantic classes.
